(19) United States
(12) Patent Application Publication
(10) Pub. No.: US 2015/0309705 A1
(43) Pub. Date: Oct. 29, 2015

(54) SYSTEM AND METHOD OF THREE-DIMENSIONAL VIRTUAL COMMERCE ENVIRONMENTS

(71) Applicants: James D. Keeler, Austin, TX (US); Arthur T. Niemeyer, Austin, TX (US); Bruce A. Mayer, Austin, TX (US); Mitchell D. Wilson, Austin, TX (US); Matthew C. Brace, Austin, TX (US)

(72) Inventors: James D. Keeler, Austin, TX (US); Arthur T. Niemeyer, Austin, TX (US); Bruce A. Mayer, Austin, TX (US); Mitchell D. Wilson, Austin, TX (US); Matthew C. Brace, Austin, TX (US)

(73) Assignee: Invodo, Inc., Austin, TX (US)

(21) Appl. No.: 14/698,505

(22) Filed: Apr. 28, 2015

Related U.S. Application Data
(60) Provisional application No. 61/985,304, filed on Apr. 28, 2014.

(51) Int. Cl. G06F 3/0484; G06Q 30/06; G06N 5/04

(52) U.S. Cl. CPC G06F 3/04842; G06N 5/04; G06Q 30/0643

(57) ABSTRACT

In one or more embodiments, one or more systems, methods, and/or processes can provide information to a virtual reality device and/or an augmented reality device, among others, of a user/customer. The information can be associated with offerings of goods and/or services for sale, purchase, or rent. Determining the information can be based on past actions of the user and/or other users. For example, the determined information can be inferred from past actions of the user and/or other users. In one or more embodiments, a layout of a virtual store and/or presentations of one or more items can be based on past actions of the user and/or other users. In one or more embodiments, one or more of the layout of the virtual store and/or providing (e.g., via augmented reality or virtual reality) the information associated with the goods and/or services can be determined and/or chosen to maximize sales and/or profits.

This Application claims priority to U.S. Provisional Application Ser. No. 61/985,304, filed 28 Apr. 2014, titled “System and Method of Three-Dimensional Virtual Commerce Environments”. Each of U.S. application Ser. No. 13/601,537, filed 31 Aug. 2012, titled “Methods and Systems of Providing Items to Customers Via a Network”, Ser. No. 13/428,128, filed 23 Mar. 2012, titled “Methods And Systems Of Providing Items To Customers Via a Network”; U.S. Provisional Applications Ser. No. 61/627,349, filed 11 Oct. 2011, titled “Methods and Systems of Providing Items to Customers via a Network”; and U.S. Provisional Application Ser. No. 61/985,304, filed 28 Apr. 2014, titled “System and Method of Three-Dimensional Virtual Commerce Environments” is hereby incorporated by reference in its entirety as though fully and completely set forth herein.

### BACKGROUND

1. Technical Field

This disclosure relates generally to the field of electronic commerce stores offering goods and/or services for sale or purchase.

2. Description of the Related Art

Electronic commerce (e-commerce) has grown in popularity over the years. Nevertheless, brick-and-mortar stores still exist and offer goods and/or services for purchase where a customer can obtain a more “hands on” experience, ask questions, and look at demonstrations and navigate through various sections of the brick-and-mortar store in an intuitive and natural way. In the past, e-commerce sales sites have lacked this level of interactivity. Various attempts have been made at bridging the gap between the brick-and-mortar stores including interactive media such as videos, “360 degree views”, and three-dimensional spin players. Despite these attempts, the gap between e-commerce and brick-and-mortar stores is still quite large. Furthermore, brick-and-mortar stores offer goods and/or services for purchase where a customer can obtain a more “hands on” experience, ask questions, and look at demonstrations and navigate through various sections of the brick-and-mortar store in an intuitive and natural way, but no suggestions based on other products and/or a customer profile are available as they are via e-commerce shopping sites.

### BRIEF DESCRIPTION OF THE DRAWINGS

The preferred embodiments will become apparent upon reading the following detailed description and upon reference to the accompanying drawings in which:

FIG. 1 provides an exemplary illustration of a layout of a physical store that can be digitized to enable a three-dimensional rendering, according to one or more embodiments;

FIG. 2 illustrates an exemplary head-mounted display and a representation of a store, as viewed via a head-mounted display, according to one or more embodiments;

FIG. 3 provides a more detailed illustration of a head-mounted device, according to one or more embodiments;

FIG. 4 provides a more detailed aspect of a representation of what may be viewed via one or more displays of a head-mounted display, according to one or more embodiments;

FIG. 5 illustrates exemplary capabilities of a virtual store, according to one or more embodiments;

FIG. 6 illustrates an exemplary virtual environment configured with an event tracking system, according to one or more embodiments;

FIG. 7 illustrates an exemplary reconfigured store layout, according to one or more embodiments;

FIG. 8 provides a further detailed aspect of a virtual environment configured to interact with a device via a head-mounted display, according to one or more embodiments;

FIG. 9 illustrates an exemplary profile-based layout of a virtual or augmented reality store, according to one or more embodiments;

FIG. 10 illustrates another exemplary profile-based layout of a virtual or augmented reality store, according to one or more embodiments;

FIGS. 11 and 12 provide exemplary selections of items, as viewed via a head-mounted display, according to one or more embodiments;

FIG. 13 illustrates exemplary related items, displayed via a head-mounted display, according to one or more embodiments;

FIG. 14A illustrates exemplary items not necessarily associated with a profile, displayed via a head-mounted display, according to one or more embodiments;

FIG. 14B illustrates an exemplary selection of an item that can be utilized in an inference, according to one or more embodiments;

FIG. 15 illustrates exemplary items necessarily associated with one or more of a profile and each other, displayed via a head-mounted display, according to one or more embodiments;

FIGS. 16A and 16B illustrate an exemplary method of providing a virtual shopping experience to a customer, according to one or more embodiments;

FIG. 17 illustrates exemplary information of exemplary database tables, according to one or more embodiments;

FIG. 18 provides an exemplary block diagram of an artificial intelligence system, according to one or more embodiments;

FIG. 19 illustrates an exemplary method of operating an artificial intelligence system, according to one or more embodiments;

FIG. 20 illustrates an exemplary method of providing and/or presenting items to a customer without a customer profile, according to one or more embodiments;

FIG. 21A illustrates a user utilizing augmented reality, according to one or more embodiments;

FIG. 21B illustrates an exemplary physical product with an exemplary graphic and/or logo, according to one or more embodiments;

FIG. 21C illustrates an exemplary graphic and/or logo, according to one or more embodiments;

FIGS. 22A and 22B illustrates an exemplary method providing an augmented reality shopping experience to a customer, according to one or more embodiments;

FIG. 23A illustrates a further detailed aspect of virtual interaction with a live person via a head-mounted display, according to one or more embodiments;

FIG. 23B illustrates a further detailed aspect of virtual interaction with a live person via an augmented reality device, according to one or more embodiments;

FIG. 24 provides an exemplary block diagram of a network communication system, according to one or more embodiments; and

FIGS. 25A-25D provides exemplary block diagrams of a computing device in various configurations, according to one or more embodiments.

While one or more embodiments may be susceptible to various modifications and alternative forms, specific embodiments thereof are shown by way of example in the drawings and will herein be described in detail. It should be understood, however, that the drawings and detailed description thereto are not intended to limit the disclosure to the particular form disclosed, but on the contrary, the disclosure is to cover all modifications, equivalents and alternatives falling within the spirit and scope of appended claims.

### DETAILED DESCRIPTION

In one or more embodiments, methods and/or systems described herein can be utilized to create and/or implement a virtual or augmented reality environment for a three-dimensional store (e.g., an establishment that offers goods and/or services for sale and/or for rent). For example, a user (e.g., a customer) can utilize a head-mounted display with a three-dimensional viewing capability to view and/or interact with the virtual three-dimensional store. For instance, the head-mounted display can be coupled to a network (e.g., an Internet) and can access a computer system that implements the three-dimensional store via the network. In one or more embodiments, a personal computing device such as a tablet computer, a mobile smart phone, or a smart watch can serve as a surrogate for a head-mounted display.

In one or more embodiments, a three-dimensional simulation can be based on a store layout. In one example, one or more CAD (computer aided design) files can store a brick-and-mortar store layout (e.g., a physical store layout). In a second example, one or more files can store a store layout that may not exist in a physical reality. In another example, one or more files can store one or more portions of a brick-and-mortar store layout and one or more portions of a store layout that may not exist in a physical reality.

In one or more embodiments, a simulated environment can utilize a media player to play media such as videos and three-dimensional models of one or more items in a store to create an interactive virtual environment. In one or more embodiments, a player can be configured to deliver event information so that customer activity can be tracked and/or recorded via a storage system and/or device. In one or more embodiments, a system can be configured with an optimizer to modify a layout of a store and placement of one or more devices within the layout of the store to maximize profit based on one or more of previous history of customer events and personalized information (e.g., profile information), among others. For example, placement of one or more items within the layout of the store can be based on customer activity that was previously tracked and/or recorded via a storage system and/or device.

In one or more embodiments, a system can be configured with an inference engine to create and/or modify a layout of a store and placement of one or more items within the layout of the store based on one or more of previous history of customer events and/or, if available, personalized information (e.g., profile information), among others. For example, selection and/or placement of one or more items within the layout of the store can be based on one or more inferences. For instance, the one or more inferences can be based on customer activity that was previously tracked and/or recorded via a storage system and/or device.

In one or more embodiments, a system can be configured to allow for virtual device interaction where a customer can interact with an actual operating system (e.g., a wireless telephone operating system, a tablet operating system, a music player operating system, a personal digital assistant operating system, etc.) in a manner as to obtain a “hands-on” experience of how a device will function prior to purchase. In one or more embodiments, a system can be configured to allow virtual live interaction with a live person to assist in a sales process. For example, one or more images of a human being (e.g., a sales and/or service person) can be captured and displayed within a virtual environment. In one or more embodiments, a system can be configured that can allow a customer to select a model that fits his or her body dimensions, try on clothing and/or devices, and to view how one or more items appear in a virtual dressing room.

In one or more embodiments, one or more systems and/or methods can display a three-dimensional view of a product by reducing high-resolution three-dimensional representations from stored files such as CINEMA 4D, CAD files, and/or other high-resolution three-dimensional images. For example, images can be incorporated into a head-mounted display that enables display of a virtual reality environment and allows a customer to interact with the virtual reality environment. For instance, multi-media files such as videos, motion pictures, and/or live operating system virtual environments can be loaded into a player within the three-dimensional simulation to allow the customer to view and interact with these systems.

In one or more embodiments, methods and/or systems described herein can be utilized to create and/or implement an augmented reality environment for a physical store (e.g., an establishment that offers goods and/or services for sale and/or for rent). For example, a user (e.g., a customer) can utilize an augmented reality device to view and/or interact with elements of the physical store. For instance, the augmented reality device can be coupled to a network (e.g., an Internet) and can access a computer system that augmented reality information to the augmented reality device via the network.

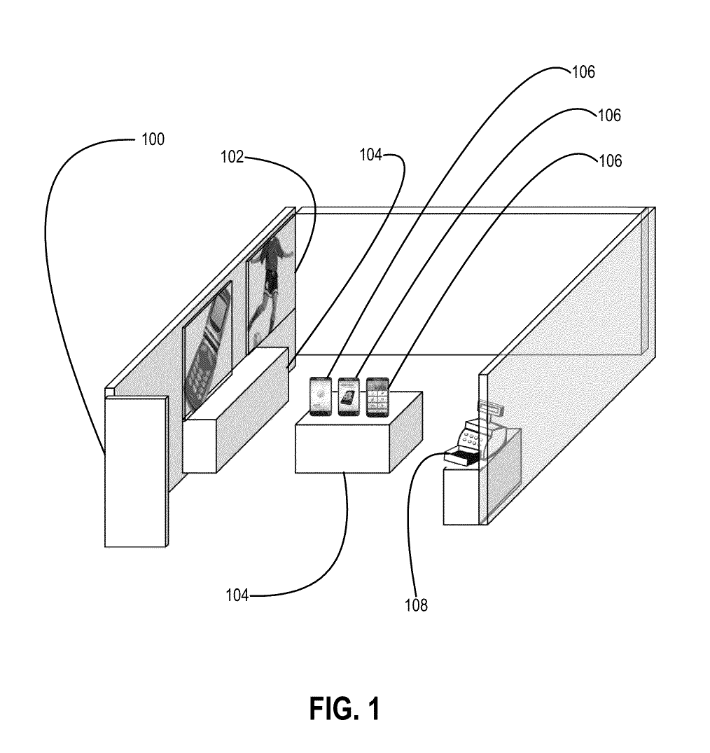

Turning now to FIG. 1, a layout of a physical store that can be digitized to enable a three-dimensional rendering is illustrated, according to one or more embodiments. As shown, a rendering of a physical store 100 can include one or more of multi-media (e.g., videos, motion pictures, etc.) 102, furniture and/or display counters 104, items and/or devices (e.g., items) 106 for sale, and checkout counter(s) 108, among others. In one or more embodiments, the rendering of store 100 can incorporate one or more locations of the one or more of multi-media 102, furniture and/or display counters 104, items and/or devices 106 for sale, and checkout counter(s) 108, among others. For example, the rendering can be utilized to generate one or more three-dimensional files that can be utilized for display by a head-mounted display, configured to be utilized by a user (e.g., a customer).

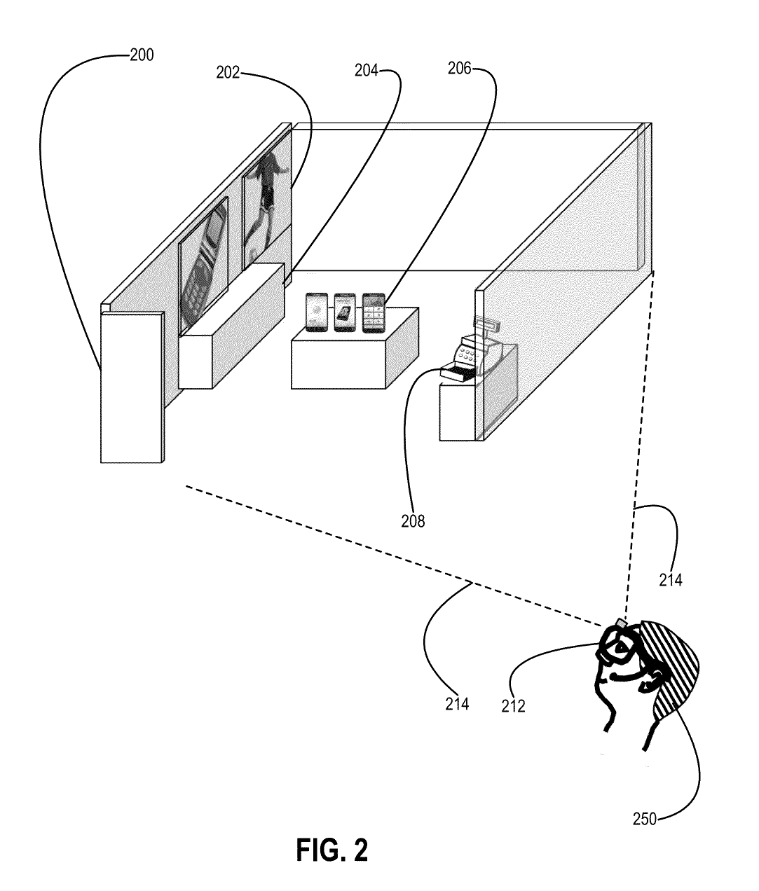

Turning now to FIG. 2, a head-mounted display and a representation of a three-dimensional store, as viewed via the head-mounted display, is illustrated, according to one or more embodiments. As shown, a customer (e.g., a user) 250 can utilize a head-mounted display (HMD) 212 to view a visually three-dimensional layout 200 of a visually three-dimensional virtual store or a store that has been virtualized. In one example, HMD 212 can include one or more structures and/or functionalities of one or more of commercially available head-mounted displays, including Oculus Rift, Google Glass, and Sony HMZ-T1, among others. In another example, HMD 212 can be implemented via wearable optics and a remote display. For instance, HMD 212 can be implemented via a three-dimensional television system utilizing a variety of commercially available technologies such as Anaglyph 3D systems, Polarized 3D systems, Active Shutter 3D systems (e.g., utilizing filters and/or lenses over eyes of a user), and/or Autosteroscopic display (Auto 3D) systems, among others. In one or more embodiments, HMD 212 can apply to and/or encompasses any video display system capable of and/or configured to display three-dimensional pictures and/or video (e.g., motion pictures, video streams, etc.) to a user.

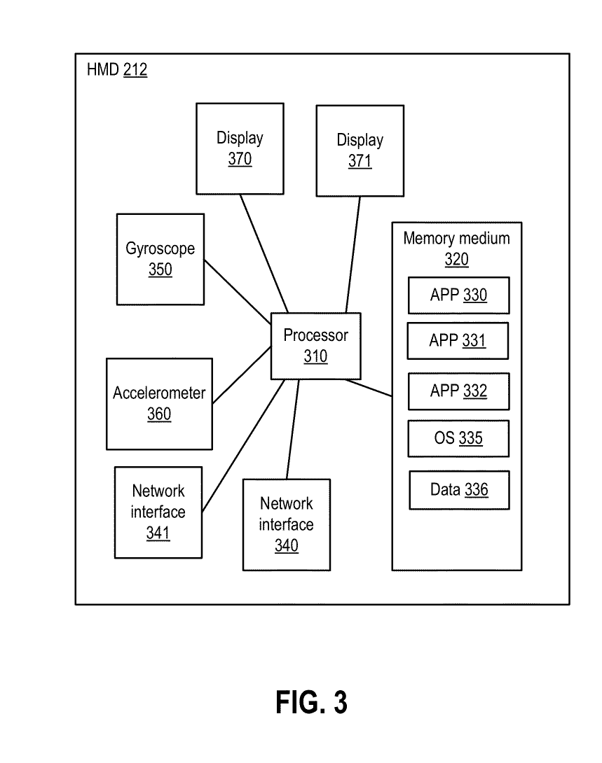

As illustrated, a view 214 of the HMD 212 can include a three-dimensional representation of what may be viewed in the view of the HMD 212. For example, view 214 can include one or more of renderings 200-208, as shown. In one or more embodiments, HMD 212 can retrieve one or more of renderings 200-208, among others, from a memory and/or storage device (e.g., a memory medium 320 illustrated in FIG. 3), and produce a three-dimensional virtual reality view 214 of a virtual environment.

In one example, physical store 100 (illustrated in FIG. 1) can be displayed in the virtual environment to represent the layout of store 200. In a second example, media displays 102 (illustrated in FIG. 1) are represented by virtual displays 202, where a media player is incorporated in the virtual display to present media. In a third example, furniture and counters 104 (illustrated in FIG. 1) are displayed within HMD 212 as renderings 204, and devices (e.g., items) 106 (illustrated in FIG. 1) are digitized to be displayed in the virtual environment as virtual devices 206. In another example, checkout locations 108 (illustrated in FIG. 1) are displayed in the virtual environment as virtual checkouts 208. In one or more embodiments, the checkout locations are enabled via application programming interfaces (APIs) with payment systems to interact with customer payment information, stored in a memory and/or storage device, that can be utilized in completing a purchase and/or a transaction.

Turning now to FIG. 3, a more detailed illustration of a head-mounted device, according to one or more embodiments, is provided. As shown, HMD 212 can include a processor 310 coupled to a memory medium 320. In one or more embodiments, memory medium 320 can store data and/or instructions that can be executed by processor 310. For example, memory medium 320 can store one or more applications (APPs) 330-332, an operating system (OS) 335, and/or data 336. For instance, one or more APPs 330-332 and/or an OS 335 can include instructions of an instruction set architecture (ISA) associated with processor 310.

In one or more embodiments, processor 310 can execute instruction from one or more of APPs 330-332 and OS 335 to implement one or more processes, systems, and/or methods described herein. For example, one or more of APPs 330-332 and OS 335 can access and/or utilize data 336 to implement one or more processes, systems, and/or methods described herein. For instance, data 336 can include three-dimensional data and/or render data, and one or more of APPs 330-332 and OS 335 can access and/or utilize the three-dimensional data and/or the render data to implement one or more processes, systems, and/or methods described herein

In one or more embodiments, HMD 212 can be coupled to and/or include one or more of a display, a keyboard, and a pointing device (e.g., a mouse, a track ball, a track pad, a stylus, etc.). In one example, the keyboard and/or the pointing device can be utilized by a user/customer to select and/or manipulate one or more items in a virtual environment. In another example, the keyboard and/or the pointing device can be utilized by the user/customer to traverse and/or navigate the virtual environment. In one or more embodiments, a touch screen can function as a pointing device. In one example, the touch screen can determine a position via one or more pressure sensors. In another example, the touch screen can determine a position via one or more capacitive sensors. In a further example the pointing location can be based on sensing the position of the eyes. In a further example, the interaction can be actuated via speech commands. In another example, the position may be determined via sensing of brain waves through EEG (electroencephalography), MRI (magnetic resonance imaging), implanted biochips or other brain-activity sensing mechanism/device, among others.

As illustrated, HMD 212 can include one or more network interfaces 340 and 341. In one example, network interface 340 can interface with a wired network coupling, such as a wired Ethernet, a T-1, a DSL modem, a PSTN, or a cable modem, among others. In another example, network interface 341 can interface with a wireless network coupling, such as a satellite telephone system, a cellular telephone system, WiMax, WiFi, or wireless Ethernet, among others.

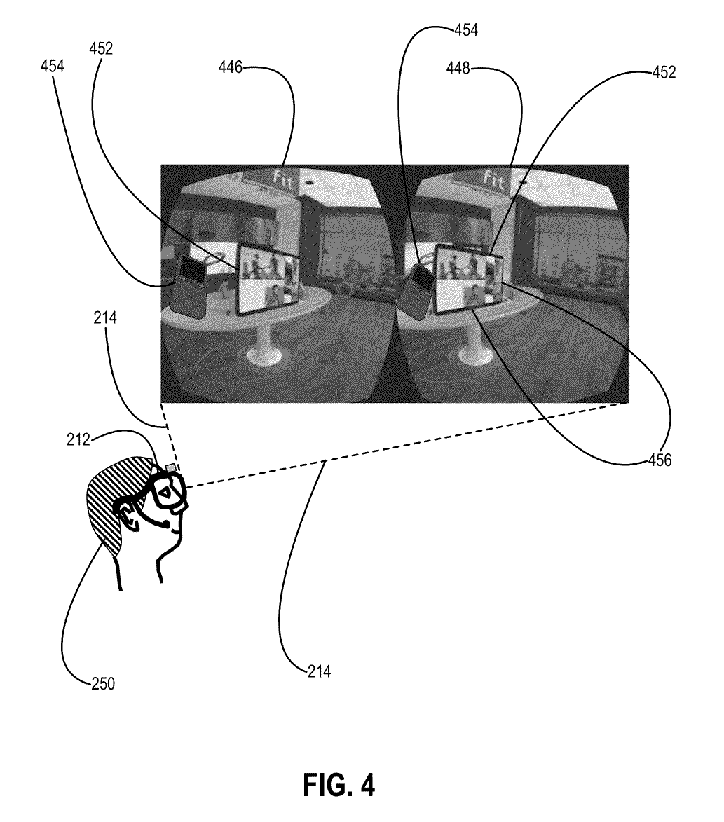

As shown, HMD 212 can include one or more displays 370 and 371 that can be coupled to processor 310. In one or more embodiments, one or more of displays 370 and 371 can display picture and/or video information to a user of HMD 212. For example, display 370 can display first picture and/or video information and display 371 can display second picture and/or video information, where the first picture and/or video information can be different from the second picture and/or video information. For instance, display 370 can display picture and/or video information 446 (illustrated in FIG. 4), and display 371 can display picture and/or video information 448 (illustrated in FIG. 4). In one or more embodiments, a single display can display both the first and second picture and/or video information, and the first and second picture and/or video information can be optically decoded (e.g., via polarized filters, color filters, etc.) by an optical device.

As illustrated, HMD 212 can include one or more of a gyroscope 350 and an accelerometer 360 that can be coupled to processor 310. In one or more embodiments, one or more of gyroscope 350 and accelerometer 360 can measure one or more of orientation and motion of HMD 212, among others. For example, each of one or more of gyroscope 350 and accelerometer 360 can be or include a microelectromechanical system that can measure one or more of orientation and motion, among others. In one or more embodiments, processor 310 can receive one or more of orientation information and motion information from at least one of gyroscope 350 and accelerometer 360, and processor 310 can display different and/or further picture and/or video information to a user of HMD 212 via one or more displays 370 and 371, based on the received one or more of orientation information and motion information. For instance, processor 310 can access and/or retrieve different and/or further picture and/or video information from data 336 based on the received one or more of orientation information and motion information.

In one or more embodiments, HMD 212 can be or be coupled to any of various types of devices, including a computer system, a server computer system, a laptop computer system, a notebook computing device, a portable computer, a personal digital assistant (PDA), a handheld mobile computing device, a mobile wireless telephone (e.g., a satellite telephone, a cellular telephone, etc.), an Internet appliance, a television device, a DVD (digital video disc) player an/or recorder device, a Blu-Ray disc player and/or recorder device, a DVR (digital video recorder) device, a wearable computing device, or other wireless or wired device that includes a processor that executes instructions from a memory medium. In one or more embodiments, processor 310 can include one or more cores. For example, each core of processor 310 can implement an ISA.

Turning now to FIG. 4, a more detailed aspect of a representation of what may be viewed via one or more displays of HMD 214 is illustrated, according to one or more embodiments. As shown, picture and/or video information 446 can be displayed to a left eye of user 250, and picture and/or video information 448 can be displayed to a right eye of user 250. For instance, picture and/or video information 446 can be displayed via display 370, and picture and/or video information 448 can be displayed via display 371.

In one or more embodiments, picture and/or video information 446 and picture and/or video information 448 can produce a three-dimensional virtual reality. For example, a brain of user 250 can combine picture and/or video information 446 and picture and/or video information 448 that can simulate and/or appear to be a three-dimensional space to implement a three-dimensional virtual reality.

As illustrated, a device 452 can be displayed via picture and/or video information 446 at a first angle and via display picture and/or video information 448 at a second angle, different from the first angle. For example, when device 452 is displayed at two different angles, device 452 can appear three-dimensional.

In one or more embodiments, devices can be individually rotated, and independently from each other. For example, device 452 can be rotated independently from device 454. In one or more embodiments, customer 250 can interact with a device via “hotspots” 456. For example, a “hotspot” can be or include an area that can allow customer 250 to interact with the device via a mouse, handset, keyboard, wand, glove, voice, head-mounted display (e.g., movement of the head moving the head-mounted display) or other interaction device. For instance, customer 250 can interact with a hotspot (e.g., clicks with a mouse on the hotspot) to activate behavior indicated by the hotspot.

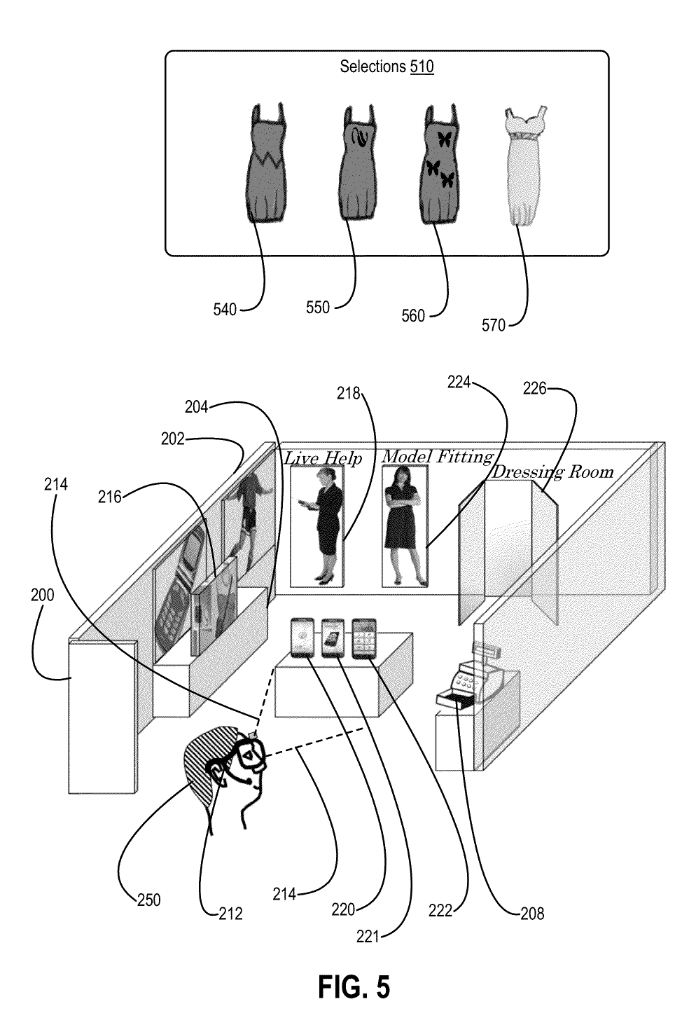

Turning now to FIG. 5, capabilities of a virtual store are illustrated, according to one or more embodiments. As shown, a virtual store can be represented via store layout 200. For example, a virtual store utilized by customer 250 can be or include store layout 200. For instance, store layout 200 can be or include a rendering of a physical store layout 100 (illustrated in FIG. 1).

In one or more embodiments, one or more items can be added to a virtual store that may not appear in a physical store. In one example, displays of items to be sold 216 can be added in the virtual environment. In a second example, one or more of virtual devices 220-222 can be added in the virtual environment. For instance, one or more of physical devices corresponding to respective one or more virtual devices 220-222 may not yet be available in physical stores. In another example, the virtual environment can also include a location for live help 218. For instance, customer 250 can talk to, interact with, and/or view a live person or a virtual person (e.g., an artificial person, artificial intelligence, etc.) or a live person via an avatar, each via a real-time communication via HMD 212.

In one or more embodiments, the virtual environment can include a feature to select sizing via a virtual model 224 and can display items for purchase or lease on this virtual model (e.g., sometimes referred to as an avatar) in a virtual dressing room 226. For example, personal model information can include fitting measurements, dress sizes, shoe sizes, etc., and can be loaded into and/or stored via memory medium 320 of HMD 212 for access in future shopping experiences.

In one or more embodiments, a customer can select an item from a selection and can select virtual model 224, where the selected item can be displayed on the virtual model. For example, customer 250 can select an item of items 540-570 of selections 510, and customer 250 can select virtual model 224 to display the selected item. For instance, customer 250 can select and/or actuate a “hotspot” of virtual model 224 to display the selected item.

In one or more embodiments, profile information can be associated with customer 250. In one example, the profile information can include one or more of a sport, a gender, a yearly income, an automobile type, a means of payment (e.g., credit card and/or billing information), an address, a marital status, a credit history, a past transaction, a past purchase, a music genre, an interest, an employment status, an age, a height, a weight, a hair color, an eye color, a shoe size, a dress size, a waist size, an inseam size, a breast size, a chest size, and a membership, among others. In another example, the profile information can include verification information, identification information, and/or authentication information, among others, to verify, identify, confirm, and/or authenticate that the shopper (e.g., the customer) is the one that is associated with and/or corresponds to the payment information.

In one or more embodiments, one or more of the verification information, the identification information, and the authentication information can include one or more forms. For example, the one or more forms can include one or more of a user name, a password, and biometric information (e.g., voice print, finger print, retinal scan information, etc.), among others. For instance, HMD 212 can access one or more of the verification information, the identification information, and the authentication information to verify, identify, confirm, and/or authenticate payment identity and/or payment information. In one or more embodiments, the profile information can be entered via customer 250 manually via HMD 250, and/or the profile information can be uploaded via a network connection such as Bluetooth, Wi-Fi, Ethernet, USB (universal serial bus), a mobile wireless telephone network (e.g., one or ore of a satellite telephone network, a cellular telephone network, etc.), an Internet, or another means via a personal device such as a mobile phone, an e-reader, a digital camera, a laptop, or any other digital media asset with information storage.

In one or more embodiments, customer 250 can select one or more items for purchase and can purchase the one or more items via HMD 212. In one example, customer 250 can checkout by interacting with checkout system 208 via HMD 212. In a second example, customer 250 can walk through a virtual reality checkout line via HMD 212. For instance, customer 250 can utilized a keyboard, a wand, a sensor glove, and/or a pointing device to indicate a path or route to traverse or walk within a virtual store layout. In another example, customer 250 can walk out of the store via HMD 212. In one or more embodiments, after payment has been verified and confirmed, the one or more items are purchased via the payment systems API, and the one or more items can be shipped to an address associated with customer 250 and/or to an address associated with profile information corresponding to customer 250.

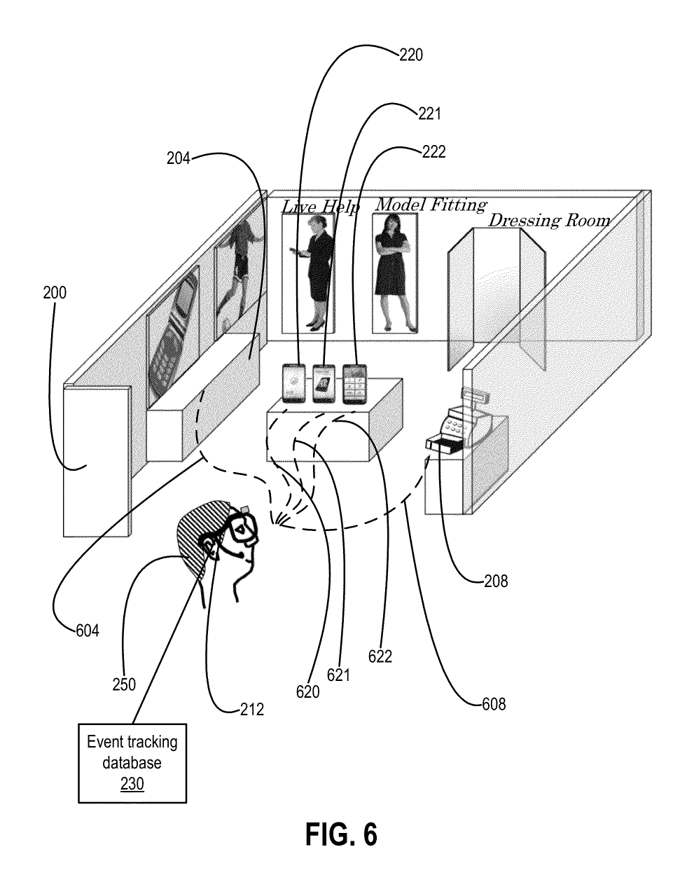

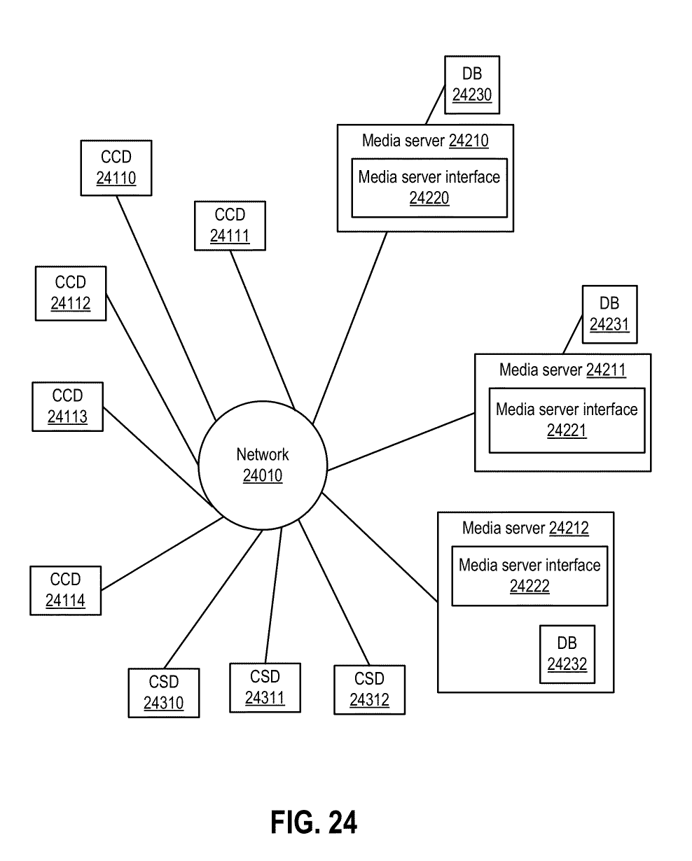

Turning now to FIG. 6, a virtual environment configured with an event tracking system is illustrated, according to one or more embodiments. As shown, HMD 212 can be coupled to an event tracking database 230. In one example, HMD 212 can be coupled to event tracking database 230 via a network. For instance, one or more of databases 24230-24232 (illustrated in FIG. 24) can include event tracking database 230, and HMD 212 can be coupled to event tracking database 230 via a network (e.g., network 24010). In another example, HMD 212 can include event tracking database 230. In one or more embodiments, HMD 212 can provide event information to event tracking database 230, and event tracking database 230 can store information provided by HMD 212.

In one example, HMD 212 can provide motion and/or path information, of customer 250 through store layout 200, to event tracking database 230. In one instance, HMD 212 can provide motion and/or path information associated with a path 604 (e.g., a path to display/furniture 204) to event tracking database 230. In a second instance, HMD 212 can provide motion and/or path information associated with a path 608 (e.g., a path to checkout 208) to event tracking database 230. In another instance, HMD 212 can provide motion and/or path information associated with paths 620-622 (e.g., associated with respective paths to devices 220-222) to event tracking database 230.

In a second example, HMD 212 can provide information associated with interactions with items for sale or lease to event tracking database 230. For instance, HMD 212 can provide information associated with interactions, of customer 250, with one or more of devices 220-222 to event tracking database 230. In a third example, HMD 212 can provide information associated with one or more amounts of time that customer 250 spends at one or more locations to event tracking database 230. In another example, HMD 212 can provide information associated with one or more purchases of one or more items to event tracking database 230.

In one or more embodiments, event tracking database 230 can calculate one or more statistical measures associated with items and/or paths in the virtual store. In one example, event tracking database 230 can calculate one or more statistical measures associated with respective one or more paths 604-622. For instance, event tracking database 230 can compare two or more statistical measures associated with respective two or more paths 604-622. In another example, event tracking database 230 can calculate one or more statistical measures associated with respective one or more devices 220-222. For instance, event tracking database 230 can compare two or more statistical measures associated with respective two or more devices 220-222.

In one or more embodiments, the statistical measures can be utilized to determine most or more popular routes, paths, items, etc. For example, a statistical measure associated with path 604 can indicate that path 604 is the most popular path among paths 604-622. For instance, statistical measure associated with path 604 can indicate that path 604 is the most heavily trafficked path among paths 604-622.

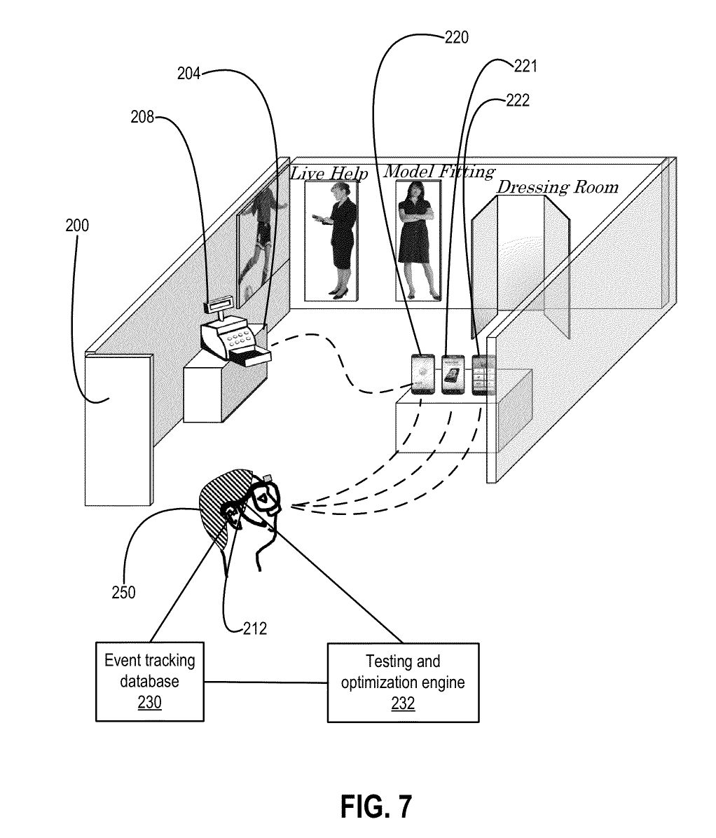

Turning now to FIG. 7, a reconfigured store layout is illustrated, according to one or more embodiments. As shown, HMD 212 can be coupled to event tracking database 230 and a testing and optimization engine 232. In one example, HMD 212 can be coupled to one or more of event tracking database 230 and testing and optimization engine 232 via a network. In another example, HMD 212 can include one or more of event tracking database 230 and testing and optimization engine 232.

In one or more embodiments, testing and optimization engine 232 can access event information from event tracking database 230 and can configure and/or reconfigure virtual store layout 200 based on the event information from event tracking database 230. For example, testing and optimization engine 232 can change store layout 200 of the virtual environment, based on the event information from event tracking database 230. In one instance, virtual checkout 208 can be moved to a different location. In a second instance, in a virtual reality environment, walls can be moved, extended, and/or changed, whereas in an augmented reality environment, physical objects remain unchanged.

In one or more embodiments, testing and optimization engine 232 can provide configuration information, reconfiguration information, and/or change information to HMD 212. For example, HMD 212 can receive the configuration information, reconfiguration information, and/or change information; can store the configuration information, the reconfiguration information, and/or the change information via memory medium 320 (illustrated in FIG. 3); and can display a virtual environment, based on the configuration information, the reconfiguration information, and/or the change information, to customer 250.

In one or more embodiments, testing and optimization engine 232 can test different configurations and/or changes to determine if the different configurations and/or changes increase purchases in the virtual environment. For example, testing and optimization engine 232 can test if changing a location of virtual checkout 208, from its location as illustrated in FIG. 6 to a location as illustrated in FIG. 7, increases purchases in the virtual environment.

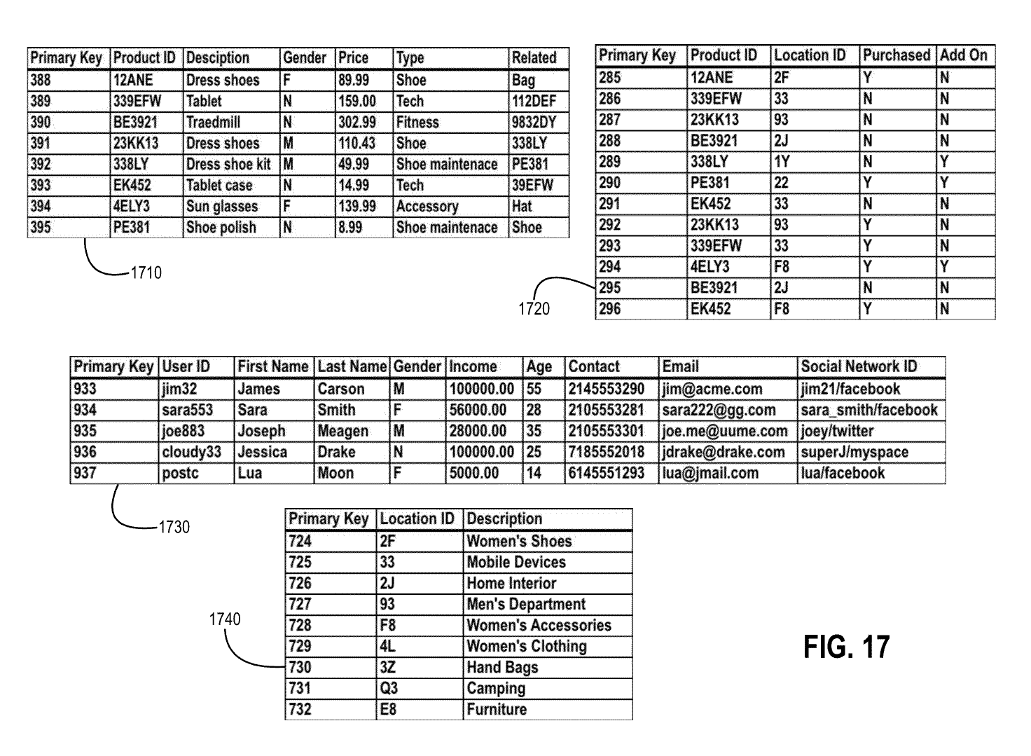

In one or more embodiments, results of testing in a virtual environment can be utilized to configure and/or change future virtual environments. In one or more embodiments, the virtual environment layout can be changed based on a profile of a customer. For example, testing and optimization engine 232 can configure a virtual environment based on information of a profile of customer 250. In one or more embodiments, results of virtual environment testing can be utilized in configuring, modifying, and/or changing present and/or future physical store layouts. In one or more embodiments, testing and optimization engine 232 can include one or more structures and/or one or more functionalities of artificial intelligence system. For example, testing and optimization engine 232 can include one or more structures and/or one or more functionalities of artificial intelligence system 1810 (illustrated in FIG. 18).

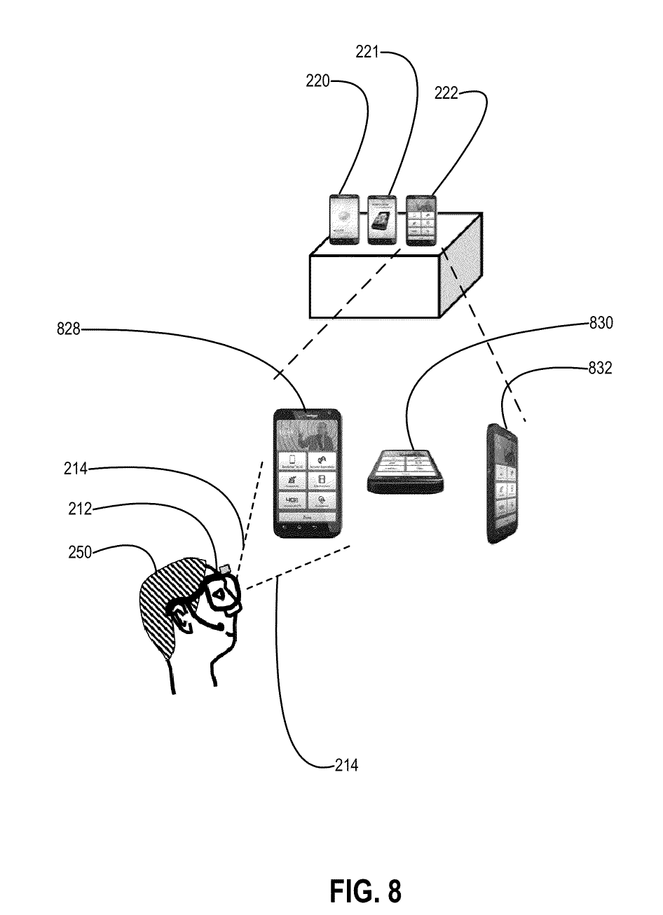

Turning now to FIG. 8, a further detailed aspect of a virtual environment configured to interact with a device via a HMD is illustrated, according to one or more embodiments. In one or more embodiments, HMD 212 can receive user input from customer 250 that selects a device. For example, HMD 212 can receive user input from customer 250 that selects device 222 from among devices 220-222. In one or more embodiments, HMD 212 can receive user input from customer 250 that indicates one or more of an expanded view of a device and a rotation of the device, among others. For example, one or more “hotspots” associated with a display of device 222 can be selected that can expand a view of device 222, that can rotate device 222, etc. In one instance, HMD 212 can display device 222 via an expanded view 828. In another instance, HMD 212 can display device 222 via different display angles 830 and 832.

In one or more embodiments, customer 250 can interact with a virtual device via a virtual machine. For example, customer 250 can interact with virtual device 222, and virtual device 222 can be executing on a virtual machine. For more information regarding a virtual device executing on a virtual machine, please refer to U.S. application Ser. No. 13/601,537, filed 31 Aug. 2012, titled “Methods and Systems of Providing Items to Customers Via a Network”.

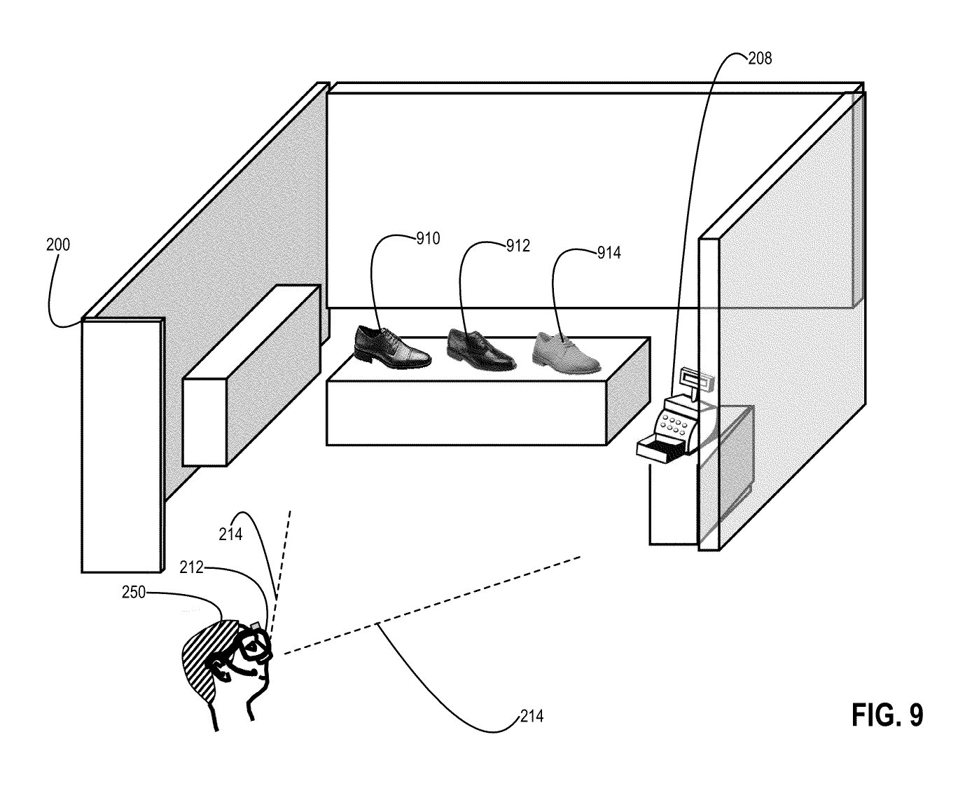

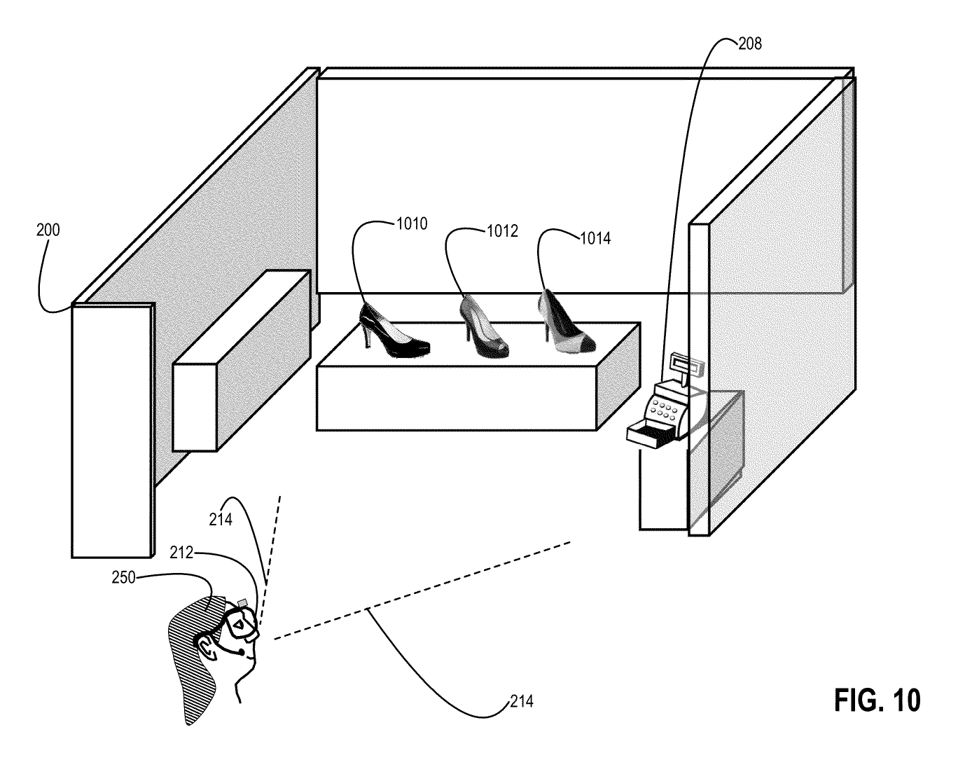

Turning now to FIGS. 9 and 10, a head-mounted display and user profile-based representations of a store, as viewed via the head-mounted display, are illustrated, according to one or more embodiments. As shown in FIG. 9, customer/user 250 can utilize HMD 212 to view a profile-based layout of a virtual store. For example, a profile associated with customer/user 250 can store and/or indicate information associated with customer/user 250. For instance, profile information associated with customer/user 250 can indicate that customer/user 250 is a male, and layout of virtual store 200 can be configured to display shoes (e.g., items) 910-914 for men.

As illustrated in FIG. 10, customer/user 250 can utilize HMD 212 to view a profile-based layout of a virtual store. For instance, profile information associated with customer/user 250 can indicate that customer/user 250 is a female, and layout of virtual store 200 can be configured to display shoes (e.g., items) 1010-1014 for women.

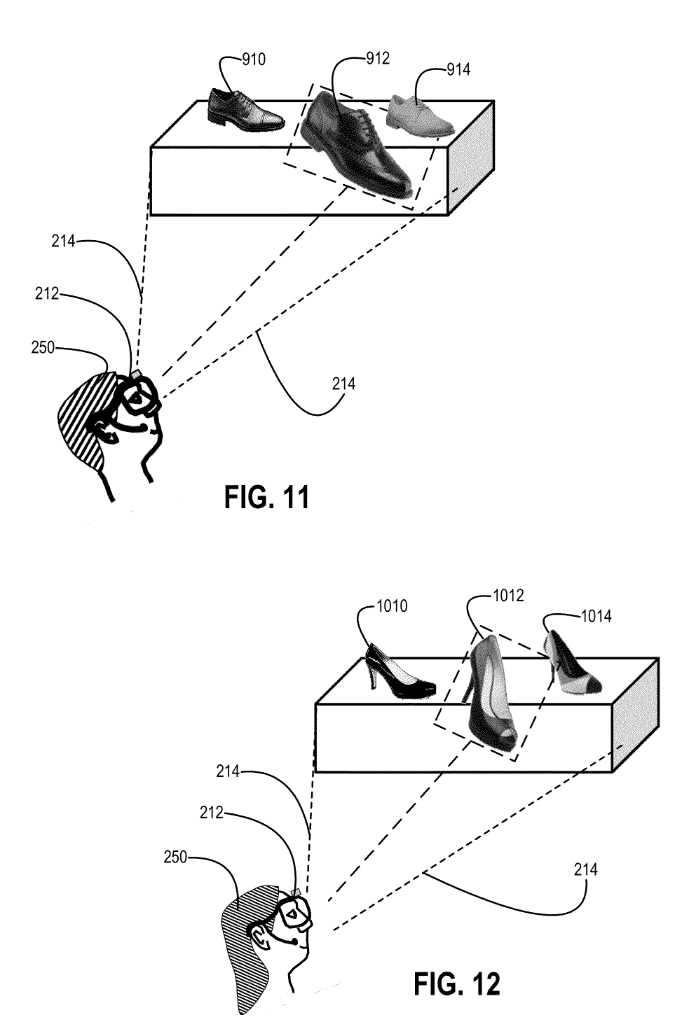

Turning now to FIGS. 11 and 12, selection of an item, as viewed via the head-mounted display, are illustrated, according to one or more embodiments. As shown in FIG. 11, customer/user 250 can select and view item 912 (e.g., a shoe). As illustrated in FIG. 12, customer/user 250 can select and view item 1012 (e.g., a shoe).

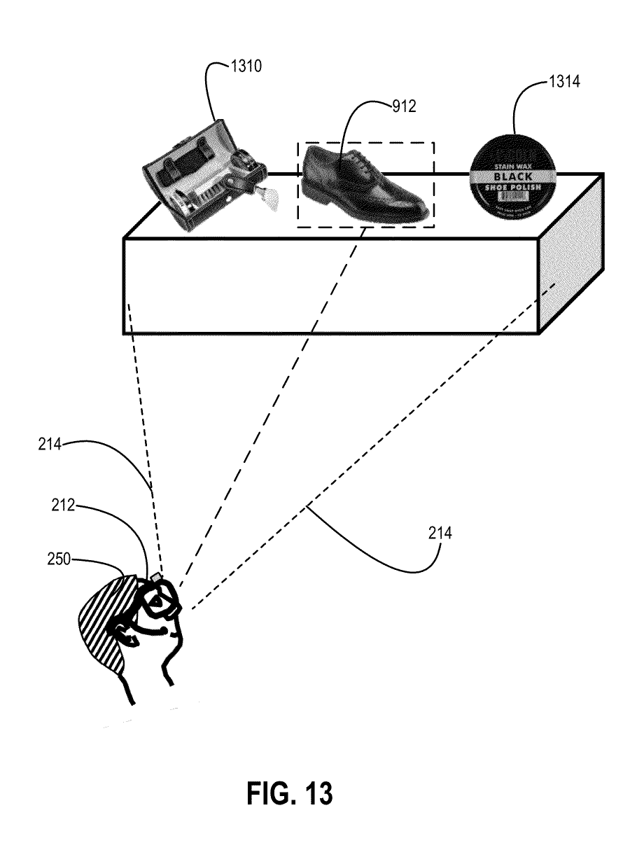

Turning now to FIG. 13, exemplary related items are displayed via a head-mounted display, according to one or more embodiments. As shown, one or more related items 1310 and 1314 can be displayed to user 250. For example, the one or more related items 1310 and 1314 can be displayed to user 250 based on a selection of item 912. For instance, user 250 can select shoe 912 and one or more of shoe polish kit 1310 and shoe polish 1314, among others, can be displayed and/or presented to user 250 via HMD 212.

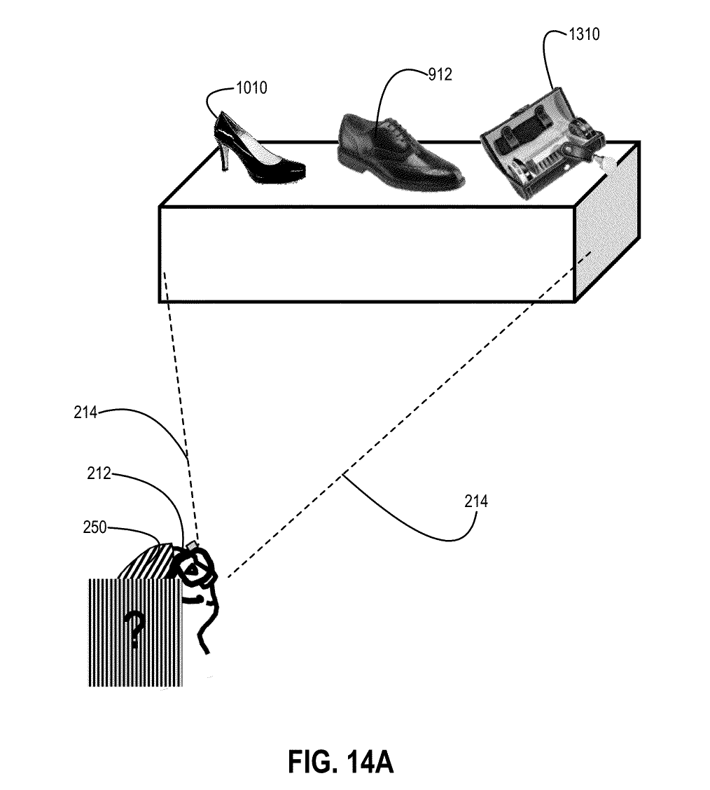

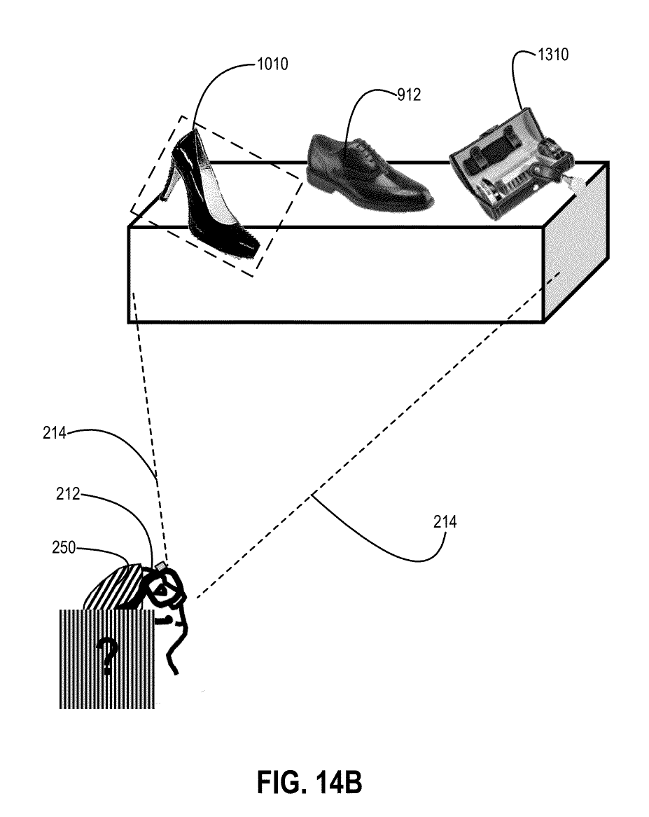

Turning now to FIG. 14A, exemplary items not necessarily associated with a profile are displayed, via a head-mounted display, according to one or more embodiments. As shown, women's shoe 1010, men's shoe 912, and shoe polish kit 1310 can be displayed to user 250 via HMD 212. In one example, profile information may not be available for user 250, and items related to a male gender and a female gender can be displayed to user 250. In another example, some profile information may be available for user 250 while some other profile information may not be available. For instance, gender information may not be available and items related to a male gender and a female gender can be displayed to user 250. As illustrated, shoe polish kit 1310 can be related to one or more of women's shoe 1010 and men's shoe 912, and shoe polish kit 1310 can be displayed to user 250.

Turning now to FIG. 14B, an exemplary selection of an item that can be utilized in an inference is illustrated, according to one or more embodiments. As shown, women's shoe 1010 can be selected. In one or more embodiments, after receiving one or more selections of respective one or more items, other items and/or profile information can be inferred based on the one or more selections of the respective one or more items. In one example, after receiving a selection of women's shoe 1010, an inference that user 250 is a female can be made and/or determined. In another example, after receiving a selection of women's shoe 1010, an inference that user 250 is shopping for female items can be made and/or determined.

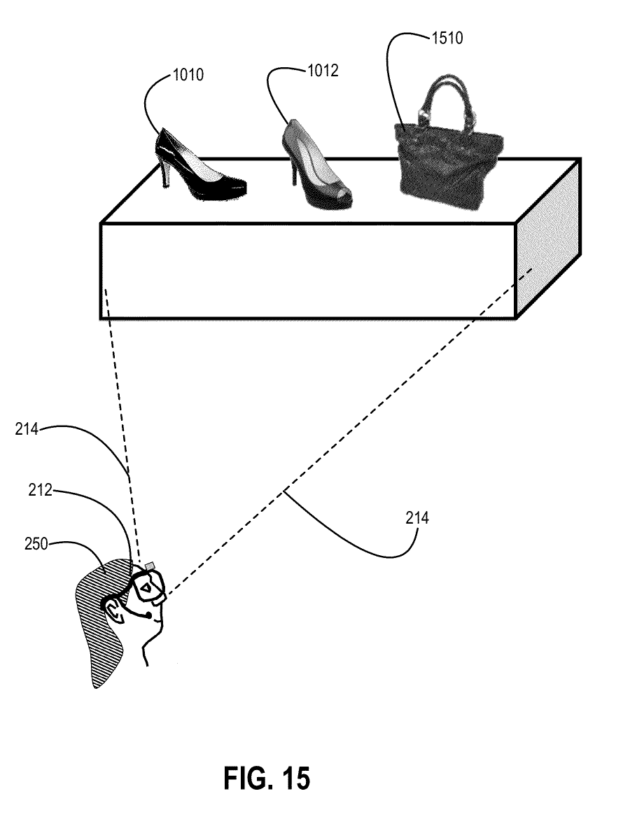

Turning now to FIG. 15, exemplary items necessarily associated with one or more of a profile and each other are displayed via a head-mounted display, according to one or more embodiments. As shown, items 1010, 1012, and 1510 can be displayed to user 250 via HMD 212. For example, women's shoe 1010 and women's hand bag 1510 can be displayed to user 250 via HMD 212 based on an inference associated with the selection of item 1010 (e.g., see FIG. 14B).

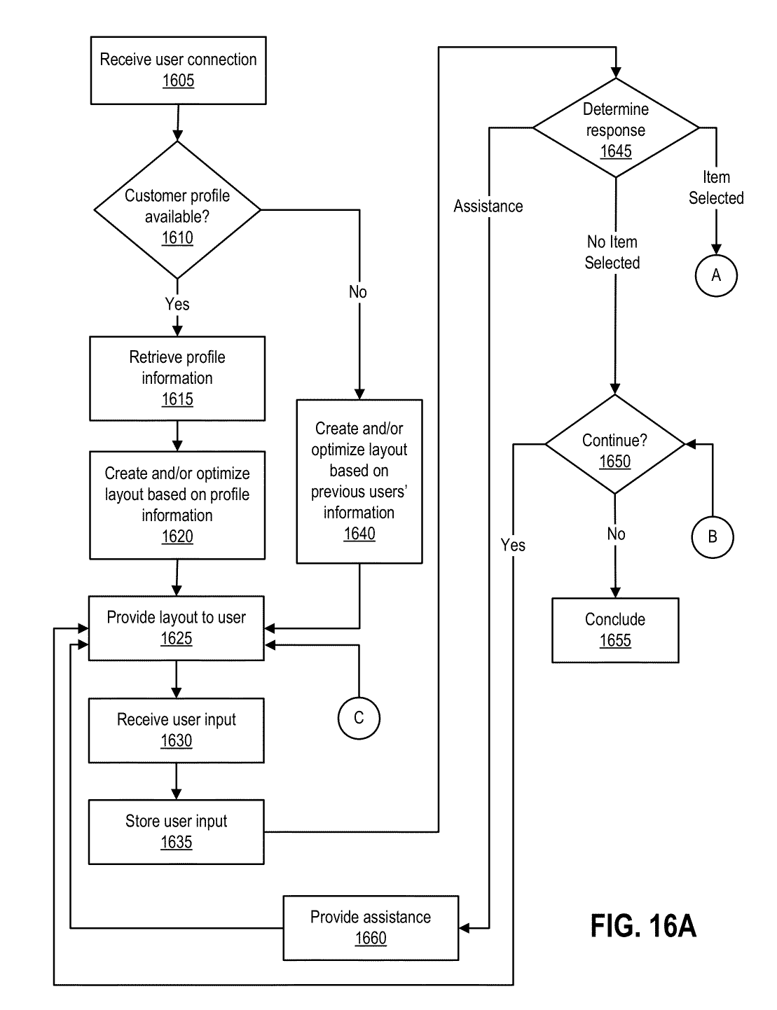

Turning now to FIGS. 16A and 16B, a method providing a virtual shopping experience to a customer is provided, according to one or more embodiments. At 1605, a connection from a user (e.g., a customer) can be received. In one or more embodiments, a connection from user 250 (e.g., a customer) can be received. For example, the connection from user 250 can be received via network 24010 (illustrated in FIG. 24).

At 1610, it can be determined if a customer profile is available. In one or more embodiments, determining if a customer profile is available can include accessing a database. For example, one or more of databases (DBs) 24230-24232 (FIG. 24) can accessed to determine if a customer profile is available.

If a customer profile is available, profile information can be retrieved at 1615. For example, the profile information can be retrieved from one or more of DBs 24230-24232. At 1620, a layout based on profile information of the customer profile can be created and/or optimized. For example, layout 200 of a virtual store can be created and/or optimized based on profile information of the customer profile of user 250.

In one instance, the profile information associated with user 250 can indicate that user 250 is a male, and men's items can be presented to user 250 (e.g., see FIG. 9). In a second instance, the profile information associated with user 250 can indicate that user 250 is a female, and women's items can be presented to user 250 (e.g., see FIG. 10). In another instance, the profile information associated with user 250 can indicate other information, and layout 200 of a virtual store can be created and/or optimized based on one or more of a sport, a yearly income, an automobile type, a means of payment (e.g., credit card and/or billing information), an address, a marital status, a credit history, a past transaction, a past purchase, a music genre, an interest, an employment status, an age, a height, a weight, a hair color, an eye color, a shoe size, a dress size, a waist size, an inseam size, a breast size, a chest size, and a membership, among others.

If a customer profile is not available, a layout based on previous users' information, at 1640. For example, layout 200 of a virtual store can be created and/or optimized based previous customers' buying patterns. For instance, layout 200 of a virtual store can be created and/or optimized by an artificial intelligence system (e.g., artificial intelligence system 1810, illustrated in FIG. 18) based previous customers' buying patterns. At 1625, the layout can be provided to the user. For example, layout 200 can be provided to HMD 212 of user 250. For instance, layout 200 can be provided to HMD 212 via a network.

At 1630, user input can be received. In one example, user input from customer 250 that selects an item can be received. In a second example, user input from customer 250 indicating that user 250 moved from one position of layout 200 to another position in layout 200 can be received. For instance, the user input from customer 250 can include path information, such as path information associated with one or more paths 620-622 (illustrated in FIG. 6). In another example, user input from customer 250 that requests assistance can be received. In one or more embodiments, user input from customer 250 can be or include passive input. For example, a timer can measure one or more amounts of time transpiring that can indicate one or more amounts of time that user 250 spends at one or more locations, spends with one or more items, and/or spends traversing one or more paths.

At 1635, the user input can be stored. In one example, the user input can be stored via one or more of DBs 24230-24232. In another example, the user input can be stored via event tracking database (DB) 230 (FIG. 7).

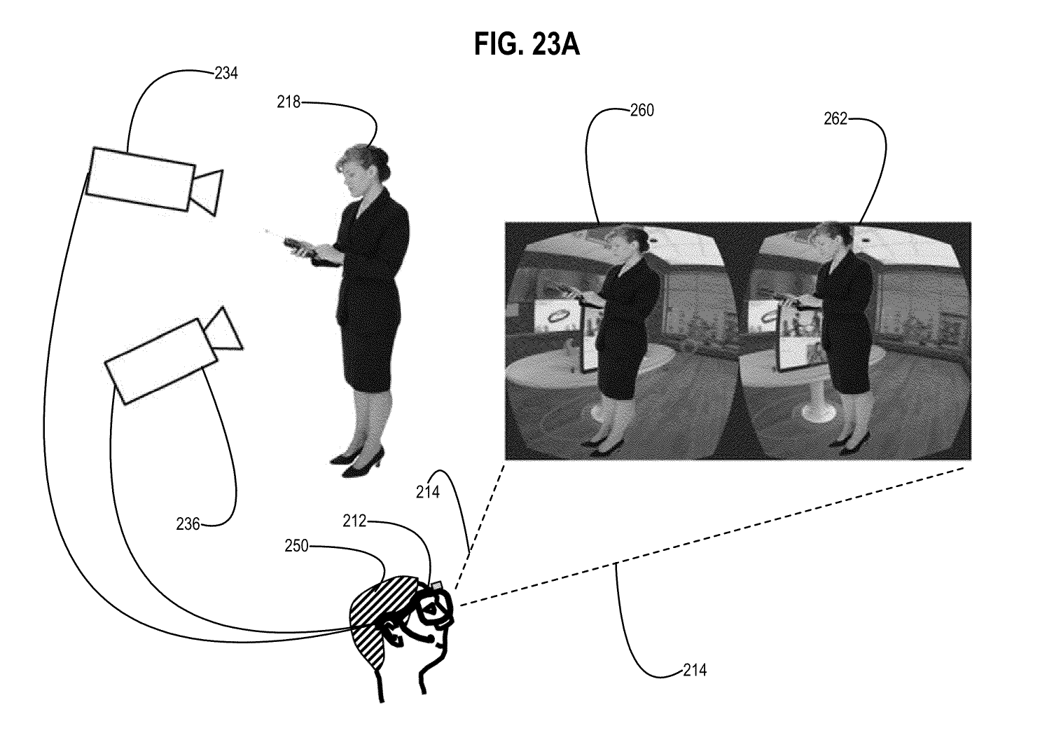

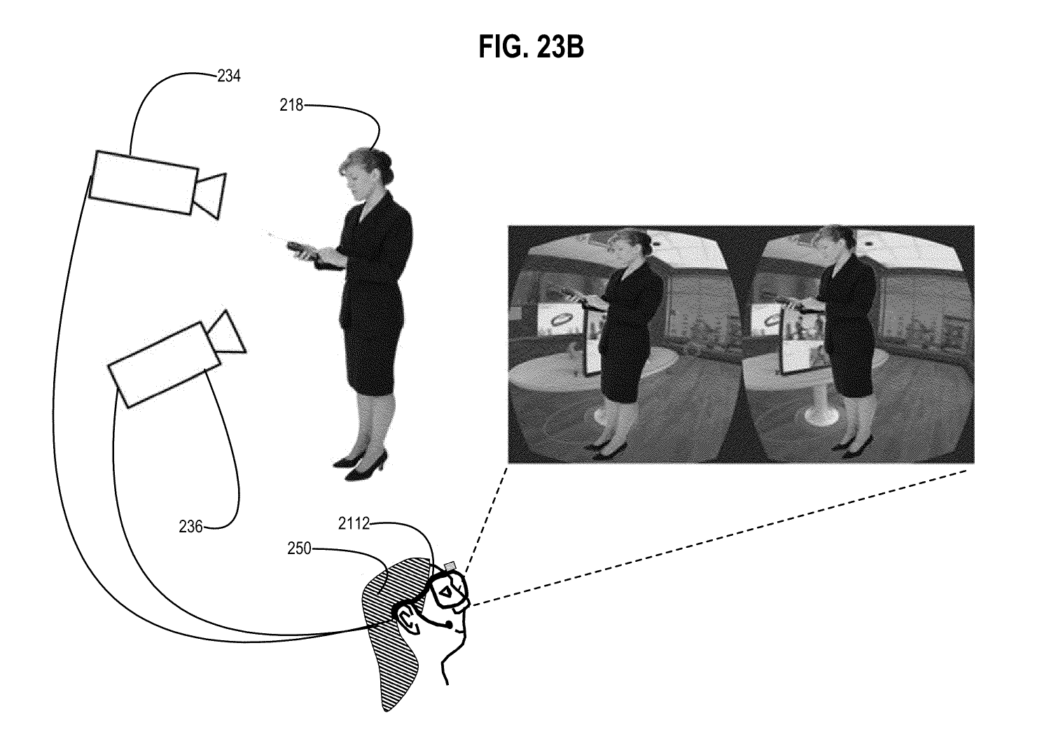

At 1645, a response to the user input can be determined. If the user input indicates that assistance is requested, assistance can be provided at 1660. For example, user 250 can receive assistance from a person 218 (FIG. 23A) via HMD 212. If no item is selected, it can be determined if further items and/or layouts are to be continued at 1650. If further items and/or layouts are to be continued, the method can proceed to 1625. If further items and/or layouts are not to be continued, the method can conclude at 1655.

With reference again to 1645, if the user input indicates that an item is selected, an “add to cart” feature can be provided at 1665. At 1670, user input can be received, and the user input can be stored at 1675. At 1680, it can be determined if the user input indicates that the user would like to purchase the item. In one example, user 250 can navigate to register 208 to indicate that user 250 would like to purchase the item. In another example, user 250 can deselect the item or place the item back on a virtual shelf to indicate that user 250 would not like to purchase the item.

If the user input indicates that the user would like to purchase the item, checkout/settlement options can be provided to the user at 1685. For example, the checkout/settlement options provided to the user can include one or more of a cost of the item, a tax on the item, a delivery cost for the item, a delivery time for the item, a delivery option for the item, a pickup option for the item, and a compensation option, among others.

At 1690, compensation can be received. In one example, compensation can be received via a funds transfer. In one instance, the funds transfer can include debiting a credit card or a debit card of user 250. In another instance, the funds transfer can include debiting an account (e.g., a bank account, an accrual bill, etc.). In a second example, compensation can be received via a collect on delivery post process. In another example, compensation can be received via an in store pickup process. For instance, the in store pickup process can include receiving compensation via cash and/or debiting an account associated with user 250. In one or more embodiments, method elements can be performed in varying orders. For example, element 1690 can be performed to accommodate and/or coordinate with an in store pickup process and/or a collect on delivery post process, among others.

At 1692, a transaction can be stored. For example, the transaction associated with purchasing and/or receiving the selected item can be stored. For instance, the transaction can be stored via one or more of DBs 24230-24232 (FIG. 24). At 1694, the transaction can be processed. For example, processing the transaction can include one or more of debiting an account associated with user 250, providing item and/or delivery information to a warehouse and/or a shipping company/service, and providing the item to user 250 via a network (e.g., network 2410), among others. In one or more embodiments, an item can be or include instructions executable by a processor (e.g., software, firmware, etc.) and/or data (e.g., one or more music files, one or more video files, one or more motion pictures, one or more pictures, one or more pass codes, one or more license keys, one or more vouchers, one or more video streams, one or more live video feeds, one or more electronic books (ebooks), one or more electronic magazines (emagazines), one or more electronic newspapers (enewspapers), etc.), and processing the transaction can include providing the item to one or more of a device of user 250 via a network (e.g., network 24010) and a device of another user via a network (e.g., network 24010), among others.

At 1696, a layout can be optimized based on one or more of transaction information, previous users' information, and profile information of the user (e.g., user 250), among others. In one or more embodiments, layout 200 can be optimized based on one or more inferences determined by artificial intelligence system 1810 (illustrated in FIG. 18).

In one or more embodiments, layout 200 can be optimized based on the transaction associated with one or more of method elements 1685-1694. In one example, the transaction can include a valued item. For instance, layout 200 can be optimized, based on the value item, to include one or more other items that are similarly valued. In a second example, the transaction can be associated with one or more of a sport, a gender, an automobile type, a marital status, a music genre, an interest, an age, a height, a weight, a hair color, an eye color, a shoe size, a dress size, a waist size, an inseam size, a breast size, a chest size, and a membership, among others. For instance, layout 200 can be optimized based on the one or more of the sport, the gender, the automobile type, the marital status, the music genre, the interest, the age, the height, the weight, the hair color, the eye color, the shoe size, the dress size, the waist size, the inseam size, the breast size, the chest size, and the membership, among others. In one or more embodiments, the method can proceed to 1625.

With reference again to method element 1680, if the user input indicates that the user would not like to purchase the item, a coupon/discount can be provided at 1698. In one example, the coupon/discount can be provided for the item. In another example, the coupon/discount can be provided for another item that is similar and/or related to the item that the user did not desire to purchase. In one or more embodiments, the method can proceed to 1650.

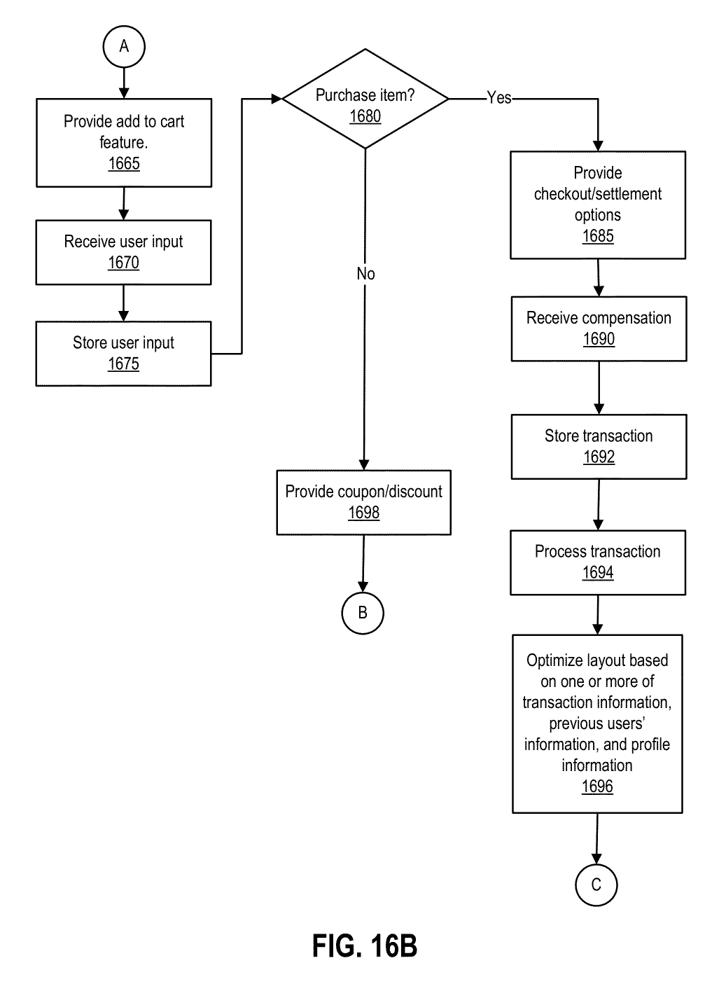

Turning now to FIG. 17, exemplary information of exemplary tables is illustrated, according to one or more embodiments. As shown, various information can be stored via one or more of tables 1710-1740. In one or more embodiments, one or more of tables 1710-1740 can be stored by and/or utilized by one or more of DBs 24230-24232 (FIG. 24).

As illustrated via a table 1710, products can be associated with one or more of a product identification (product ID), a description, a gender, a price, a type, and a related product. In one example, a first product can be associated with one or more of a product ID of “12ANE”, “Dress shoes”, a gender of female, a price of 89.99, a type of “Shoe”, and a related item of “Bag”. For instance, the first product can be dress shoe 1010 which can be related to one or more hand bags (e.g., such as hand bag or purse 1510). In another example, a second product can be associated with one or more of a product ID of “23KK13”, “Dress shoes”, a gender of male, a price of 110.43, a type of “Shoe”, and a related item of product ID 338LY. For instance, the second product can be dress shoe 912 which can be related to dress shoe kit 1310.

In one or more embodiments, products can be associated with other attributes and/or items. In one example, table 1710, while not specifically illustrated, can associate products with one or more of an automobile type, a marital status, a music genre, an interest, an age, an age range, a height, a weight, a hair color, an eye color, a shoe size, a dress size, a waist size, an inseam size, a breast size, a chest size, and a membership, among others. In another example, other tables, while not specifically illustrated, can associate products with one or more of an automobile type, a marital status, a music genre, an interest, an age, an age range, a height, a weight, a hair color, an eye color, a shoe size, a dress size, a waist size, an inseam size, a breast size, a chest size, and a membership, among others.

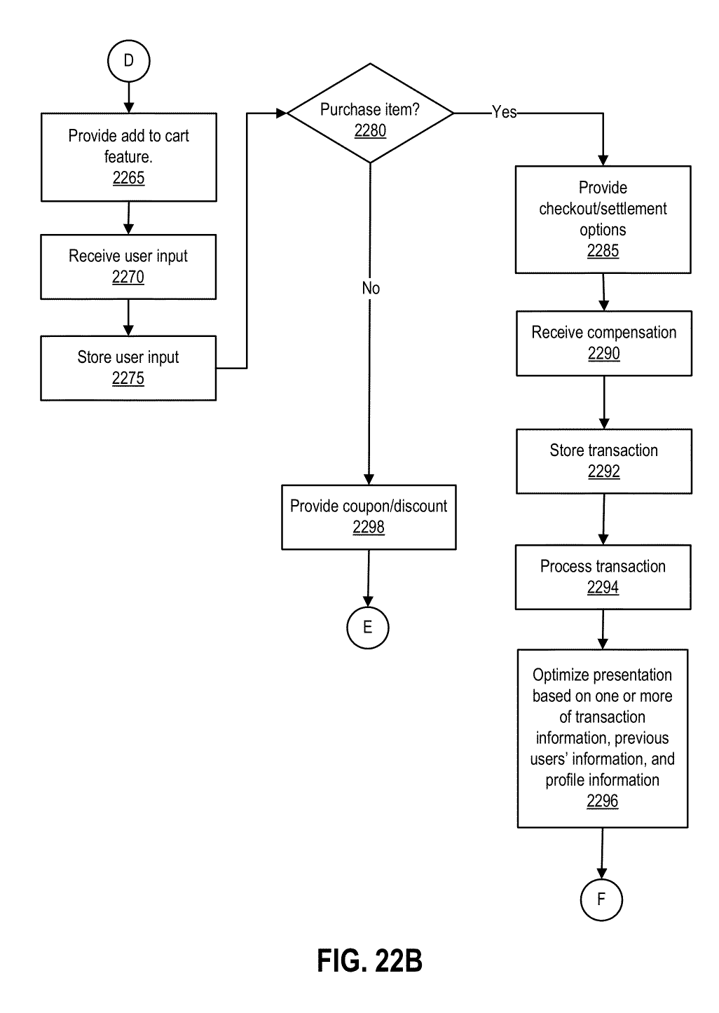

In one or more embodiments, products can be presented and/or provided at various locations of layout 200, and these locations and/or other attributes (e.g., purchased indications, add on indications, etc.) can be utilized in optimizing and/or creating layout 200 for a user. As illustrated via exemplary table 1720, products (e.g., via product IDs) can be associated with one or more of a location identification (location ID), a purchased indicator, and an add on indicator, among others. In one example, one or more of method elements 1620 (FIG. 16A), 1640 (FIG. 16A), and 1696 (FIG. 16B) can utilize information stored via table 1720. In a second example, one or more of method elements 2220 (FIG. 22A), 2240 (FIG. 22A), and 2296 (FIG. 22B) can utilize information stored via table 1720.

In a third example, after user 250 selects an item, user input can be stored (e.g., method element 1675 of FIG. 16B or method element 2275 of FIG. 22B) that can include a product ID and a location ID indicating what item and where the item was selected. In one instance, the product ID and the location ID of the product selection can be stored via table 1720, and this information can be utilized in optimizing and/or creating layout 200 for a user. In another instance, this information can be utilized in optimizing and/or creating an augmented reality presentation for a user. In another example, when a transaction is stored (e.g., method element 1692 of FIG. 16B or method element 2292 of FIG. 22B), data associated with a purchase (e.g., a product ID, a location identification, a positive purchase indication, etc.) can be stored via a table 1720. In one instance, this information can be utilized in optimizing and/or creating layout 200 for a user. In another instance, this information can be utilized in optimizing and/or creating an augmented reality presentation for a user.

As shown via table 1720, a product can be provided and/or presented at multiple locations in layout 200. In one example, a table case (product ID “EK452”) can be provided and/or presented via a “Mobile Devices” location (e.g., location ID “33” corresponding to “Mobile Devices” description in table 1740) in layout 200. In another example, a tablet case (product ID “EK452”) can be provided and/or presented via a “Women's Accessories” location (e.g., location ID “F8” corresponding to “Women's Accessories” description in table 1740) in layout 200. As illustrated in exemplary table 1720, a tablet case (product ID “EK452”) was purchased via the “Women's Accessories” location but was not purchased via the “Mobile Devices” location.

In one or more embodiments, a system that implements layout 200 can include an artificial intelligence (AI) system. For example, the artificial intelligence system can utilize data, such as data stored via one or more of tables 1710-1740, and can include and/or implement one or more of a neural network system, a rule-based expert system, an inference engine, a fuzzy logic system, a machine learning process, a Bayesian Estimator process, and a Learning Vector Quantization process, among other processes, methods, and/or systems.

Turning now to FIG. 18, an exemplary artificial intelligence system is provided, according to one or more embodiments. As shown, an AI system 1810 can include one or more of a knowledge base 1820 and an inference engine 1830. In one or more embodiments, AI system 1810 can include data (e.g., data stored in data structures, data stored in one or more databases, etc.) and instructions, executable by a processor, that operate on the data to produce one or more predictions, one or more inferences, and/or one or more store layouts, among others.

In one or more embodiments, knowledge base 1820 can include stored data (e.g., factual data, historical data, etc.) associated with a domain of AI system 1810. In one example, knowledge base 1820 can include tables 1710-1740 and the data stored via tables 1710-1740, among others. In a second example, knowledge base 1820 can include data of one or more of DBs 24230-34232 (FIG. 24). For instance, AI system 1810 can access data of one or more of DBs 24230-34232, via a network (e.g., network 24010), which can be utilized as knowledge base 1820. In another example, knowledge base 1820 can include data of and/or associated with event tracking database 230.

In one or more embodiments, inference engine 1830 can evaluate and/or interpret data of knowledge base 1820. For example, inference engine 1830 can utilize and/or apply rules 1832 to knowledge base 1820 to produce additional knowledge 1840. For instance, additional knowledge 1840 can be and/or can be categorized as “deduced new knowledge”. As additional data (e.g., new data) is collected, via one or more systems, method, and/or processes described herein, inference engine 1830 can process this additional data based on rules 1832.

In one or more embodiments, processing additional data could trigger and/or initiate additional rules of the inference engine. For example, inference engine 1830 can process a first set of data based on a first set of rules of rules 1832 and can process a second set of data, different from the first set of data, based on a second set of rules, different from the first set of rules, of rules 1832. For instance, inference engine 1830 can cycle through matching a set of rules, selecting the set of rules, and executing (e.g., applying, utilizing, etc.) the set of rules, where executing the set of rules can produce additional knowledge 1840.

In one or more embodiments, additional knowledge 1840 can be included in knowledge base 1820. For example, inference engine 1830 can cycle through matching a set of rules, selecting the set of rules, and executing the set of rules on additional knowledge 1840 after knowledge base 1820 includes additional knowledge 1840. For instance, executing the set of rules on additional knowledge 1840 after knowledge base 1820 includes additional knowledge 1840 can also produce “deduced new knowledge” of additional knowledge 1840.

In one or more embodiments, inference engine 1830 can utilize one or more modes. In one example, a first mode utilized by inference engine 1830 can include a forward chaining mode. For instance, the forward chaining mode can begin with known facts and/or historical data and deduce and/or assert new data and/or facts based on the known facts and/or historical data and rules 1832. In another example, a second mode utilized by inference engine 1830 can include a backward chaining mode. For instance, the backward chaining mode can begin with one or more goals and/or one or more end results and determine what facts and/or historical data would be utilized so that the one or more goals and/or the one or more end results could be realized.

In one or more embodiments, rules 1832 can utilize and/or include one or more sets and/or one or more series of “IF-THEN” statements. In one example, an “IF-THEN” statement can utilize definiteness. For instance, the definiteness can include determining if a user is a male. In a second example, an “IF-THEN” statement can utilize an approximate and/or a range. In one instance, the approximate can include determining if a user is around one hundred and ten pounds. In another instance, the range can include determining if a user has an income between thirty thousand dollars per year and fifty-six thousand dollars per year. In another example, an “IF-THEN” statement can utilize two or more of definiteness, approximation, and range, among others.

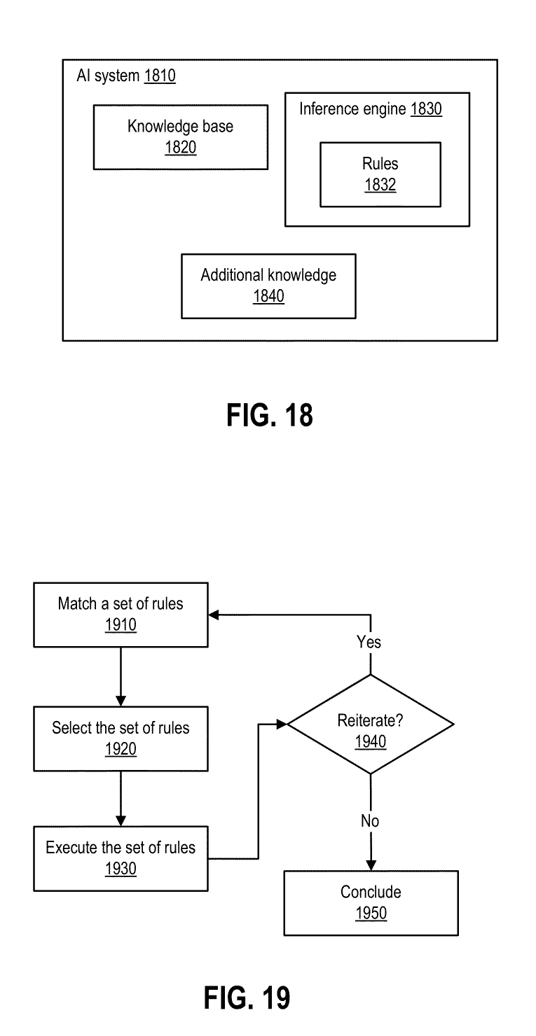

Turning now to FIG. 19, a method of operating an artificial intelligence system is illustrated, according to one or more embodiments. At 1910, a set of rules can be matched. In one or more embodiments, matching a set of rules can include inference engine 1830 determining all of rules 1832 that are triggered by current data of knowledge base 1820. In one example, when inference engine 1830 utilizes the forward chaining mode, inference engine 1830 engine searches for rules where a antecedent (e.g., left hand side, “IF” portion, etc.) matches a fact or historical data in knowledge base 1820. In another example, when inference engine 1830 utilizes the backward chaining mode, inference engine 1830 engine searches antecedents (e.g., right hand side, “THEN” portion, etc.) that can satisfy at least one of the goals and/or end results.

At 1920, the set of rules can be selected. In one or more embodiments, selecting a set of rules can include inference engine 1830 determining an order to execute the set of rules that were matched. For example, inference engine 1830 can arrange and/or prioritize the set of rules that were matched to determine the order to execute the set of rules that were matched. At 1930, the set of rules can be executed. In one or more embodiments, executing the set of rules can include inference engine 1830 executing (e.g., utilizing) each matched rule in its determined order.

At 1940, it can be determined if method elements 1910-1930 will be reiterated. In one or more embodiments, inference engine 1830 can iterate a cycle of matching a set of rules, selecting a set of rules, and executing the set of rules a number of times utilizing its produced “deduced new knowledge”. For example, inference engine 1830 can iterate a number of times utilizing its produced data the number of times as a feedback loop. In one or more embodiments, a cycle of matching a set of rules, selecting a set of rules, and executing the set of rules can continue until no rules are matched. For example, inference engine 1830 can continue to iterate matching a set of rules, selecting a set of rules, and executing the set of rules until no rules are matched. If method elements 1910-1930 will be reiterated, the method can proceed to 1910. If method elements 1910-1930 will not be reiterated, the method can conclude at 1950.

In one or more embodiments, inference engine 1830 can utilize statistical and/or probabilistic inference. For example, inference engine 1830 can utilize Bayesian inference. In one instance, Bayesian inference can include a method, a process, and/or a system of statistical inference that utilizes Bayes' rule to update a probability for a hypothesis as evidence, facts, and/or historical data are acquired. In another instance, Bayesian inference computes a posterior probability according to Bayes' theorem:

$$P ( H \vert E ) = \frac{P ( E \vert H ) \cdot P ( H )}{P ( E )} ,$$

where H is a hypothesis (e.g., a goal, an end result, etc.) that its associated probability may be affected by subsequently acquired data, E is the subsequently acquired data or “evidence”, P(H) is a prior probability or the probability of H /before E is acquired, P(H|E) is a posterior probability or a probability of H given that E is acquired or occurred, P(E|H) is a probability of acquiring E given H, and P(E) is a probability of E being acquired or occurring (e.g., a “margin of likelihood”).

For example, H can be “the user buys shoe polish kit 1310”. In one instance, E can be “the user selected shoe 912”. In a second instance, E can be “the user has purchased shoe 910”. In another instance, E can be a combination of “the user selected shoe 912” and “the user has purchased shoe 910”. If P(H|E) is at or above a threshold value, then H or “the user buys shoe polish kit 1310” is likely, e.g., “the user will likely buy shoe polish kit 1310”, and shoe polish kit 1310 kit can be provided and/or presented to the user (e.g., to user 250 via HMD 212).

In one or more embodiments, probability measures can be determined and/or computed from statistical measures and/or computations. For example, P(H) , P(E), and P(E|H) can be determined and/or computed via historical data (e.g., data stored via databases, tables 1710-1740, knowledge base 1820, additional knowledge 1840, etc.). For instance, P(H) can be determined by a total number of shoe polish kits 1310 sold divided by the total number of users presented with shoe polish kits 1310, P(E) can be determined by a total number of times the “evidence” has occurred divided by a total number of users, and P(E|J) can be determined by one or more “IF-THEN” rules, where a number of times the “evidence” has occurred where shoe polish kit 1310 was purchased divided by a total number of users.

In one or more embodiments, P(HE) can be determined and/or computed multiple times for multiple goals and/or multiple end results. For example, P(HE) can be determined and/or computed for multiple of {H₁, H₂, H₃, H₄, . . . }, and the numbers determined and/or computed, based on multiple of {H₁, H₂, H₃, H₄, . . . } can be compared against one or more thresholds to determine if an item and/or information associated with the item is to be presented to a user/customer.

In one instance, H₁ can be associated with a first item, P(H|E) is at or above a first threshold, and in response to P(H|E) being at or above the first threshold, the first item and/or information associated with the first item can be presented to the user/customer. In a second instance, H₂ can be associated with a second item (different from the first item), P(H₂E) is below a second threshold, and the second item and/or information associated with the second item may not be presented to the user/customer, since P(H₂E) is below the second threshold.

In a third instance, H₃ can be associated with a third item, P(H₃E) is at or above the second threshold, and in response to P(H₃|E) being at or above the second threshold, the third item and/or information associated with the third item can be presented to the user/customer. In another instance, H₄ can be associated with a fourth item (different from the first item, different from the second item, and different from the third item), P(H₃E) is at or above a third threshold, and in response to P(H₄E) being at or above the third threshold, the fourth item and/or information associated with the fourth item can be presented to the user/customer.

In one or more embodiments, P(HE) can be determined and/or computed multiple times for multiple evidences and/or multiple historic data. For example, P(HE) can be determined and/or computed for multiple of {E₁, E₂, E₃, E₄, . . . }, and the numbers determined and/or computed, based on multiple of {E₁, E₂, E₃, E₄, . . . } can be compared against one or more thresholds to determine if an item and/or information associated with the item is to be presented to a user/customer.

In one instance, E₁ can be associated with a first evidence and/or first historical data, P(HE₁) is at or above a first threshold, and in response to P(HE₁) being at or above the first threshold, an item and/or information associated with the item can be presented to the user/customer. In a second instance, E₂ can be associated with a second evidence and/or first historical data (different from the first evidence and/or first historical data), P(H|E₂) is below a second threshold, and the item and/or information associated with the item may not be presented to the user/customer, since P(H|E₂) is below the second threshold.

In a third instance, E₃ can be associated with a third evidence and/or first historical data (different from the first evidence and/or first historical data and different from the second evidence and/or first historical data), P(H|E₃) is at or above the second threshold, and in response to P(H|E₃) being at or above the second threshold, the item and/or information associated with the item can be presented to the user/customer. In another instance, E₄ can be associated with a fourth evidence and/or first historical data (different from the first evidence and/or first historical data, different from the second evidence and/or first historical data, and different from the third evidence and/or first historical data), P(H|E₄) is at or above a third threshold, and in response to P(H|E₄) being at or above the third threshold, the item and/or information associated with the item can be presented to the user/customer.

In one or more embodiments, two or more of the first, second, and third thresholds can be a same number. In one or more embodiments, two or more of the first, second, and third thresholds can be different numbers.

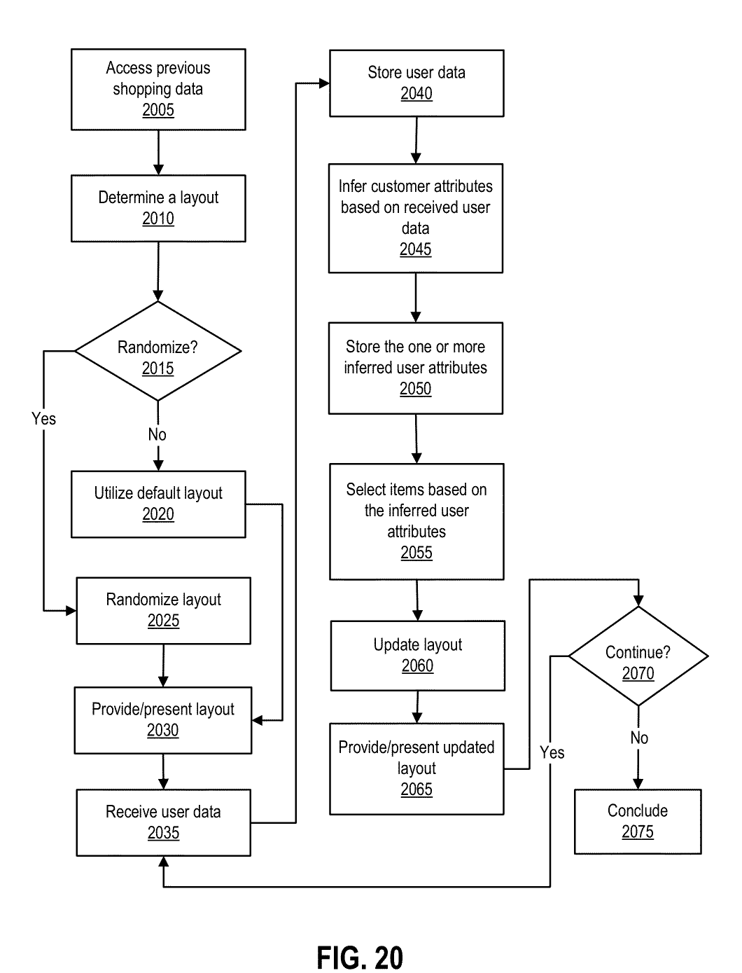

Turning now to FIG. 20, a method of providing and/or presenting items to a customer without a customer profile is illustrated, according to one or more embodiments. At 2005, previous shopping data can be accessed. For example, table 1720 (FIG. 17) can be accessed. At 2010, a layout can be determined. For example, layout 200 can be determined.

In one or more embodiments, a layout can be determined in an attempt to maximize a profit. In one example, layout 200 can be determined based on past users' (customers') behavior. For instance, the past users' behavior can include one or more of past transactions (e.g., purchasing data from table 1720), one or more selected items (e.g., selection data from table 1720), and one or more traversed paths within a store layout, among others. In another example, layout 200 can be determined based one or more attributes and/or location information. In one instance, the one or more attributes utilized in determining layout 200 can include one or more of most popular items viewed, highest volume items sold, and most commonly chosen add on items, among others. In another instance, the location information utilized in determining layout 200 can include one or more of locations where items were viewed, locations where items were purchased, and locations where items were added on, among others.

At 2015, it can be determined if a layout is to be randomized. If a layout is not to be randomized, a default layout can be utilized, at 2020. If a layout is to be randomized, a layout can be randomized, at 2025. At 2030, the layout can be provided/presented to the customer. As above and with reference to FIG. 14A, gender profile information may not be available for user 250, and at 2030, items related to a male gender and a female gender can be provided/presented to user 250. For instance, women's shoe 1010, men's shoe 912, and shoe polish kit 1310 can be provided/presented to the customer (e.g., provided/presented to user 250 via HMD 212), as illustrated in FIG. 14A.

At 2035, user data can be received. In one or more embodiments, the user data can include user input. For example, the user data can include a selection of women's shoe 1010, as above and with reference to FIG. 14B. At 2040, the user data can be stored. For example, the user data can be stored via one or more of DBs 24230-24232 and event tracking database 230. At 2045, one or more customer attributes can be inferred based on the received user data.

In one or more embodiments, AI system 1810 can infer the one or more customer attributes. For example, inference engine 1830 can determine the one or more customer attributes based on the received user data. For instance, inference engine 1830 can a gender attribute as female based on a selection of women's shoe 1010 (e.g., FIG. 14B).

At 2050, the one or more inferred customer attributes can be stored. For example, the one or more inferred customer attributes can be stored via one or more of DBs 24230-24232 (FIG. 24). For instance, the one or more inferred customer attributes can be stored via table 1730 (FIG. 17). At 2055, one or more items can be selected based on the one or more inferred customer attributes. At 2060, the layout can be updated. For example, the layout can be updated with items for women and/or of interest to women if inference engine 1830 determines a gender attribute as female.

At 2065, the layout can be provided/presented to the customer. For example, the updated layout illustrated in FIG. 15 can be provided/presented to the customer (e.g., provided/presented to user 250 via HMD 212). At 2070, it can be determined if further interaction is to be continued. If further interaction is to be continued, the method can proceed to 2035. If further interaction is not to be continued, the method can conclude at 2075.

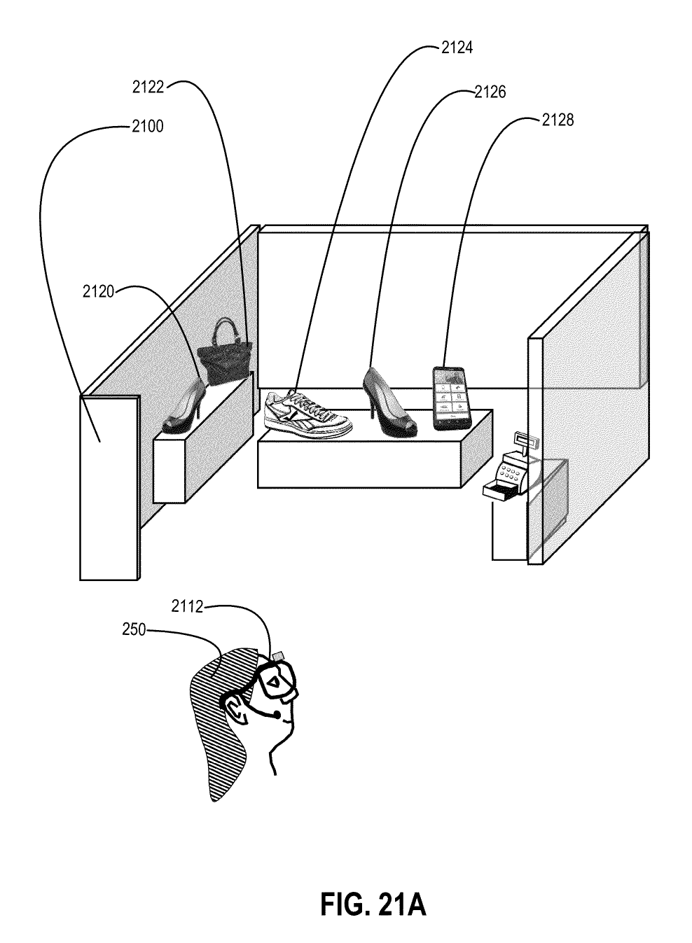

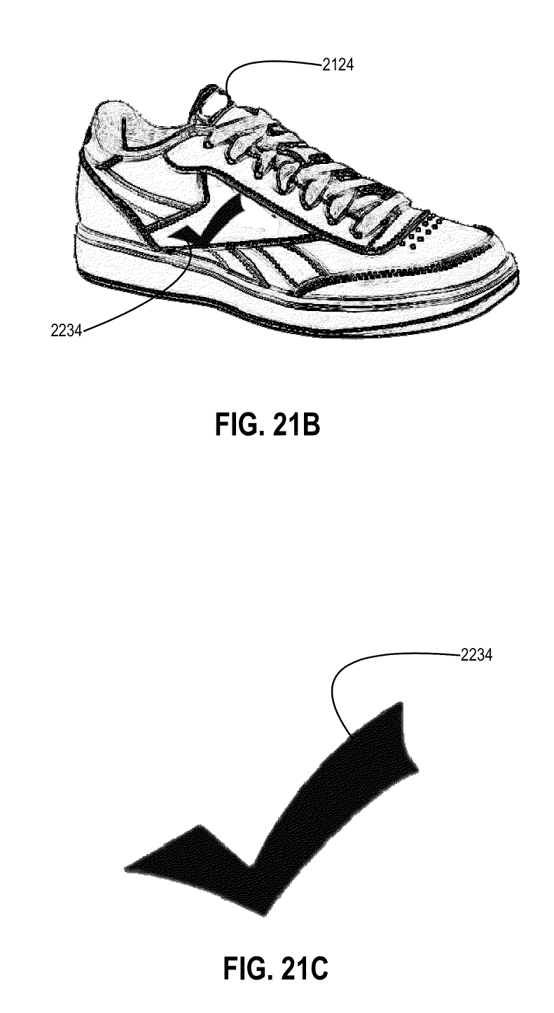

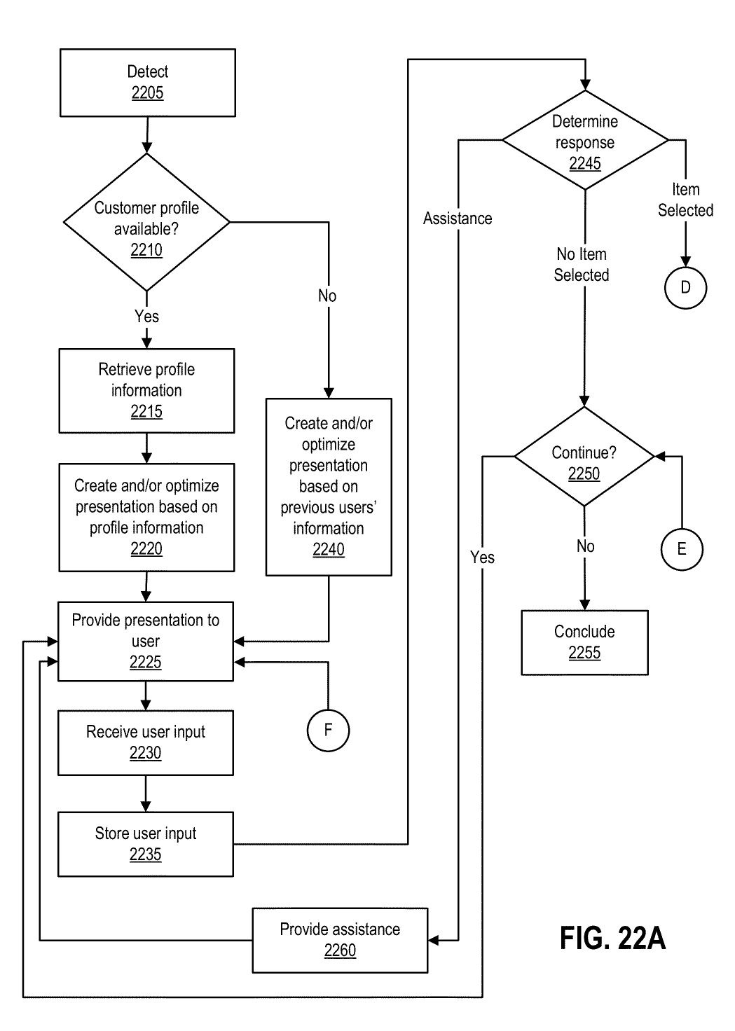

Turning now to FIG. 21A, a user utilizing augmented reality is illustrated, according to one or more embodiments. As shown, user 250 can utilize an augmented reality (AR) device 2212. Some examples of AR devices include SmartEyeglass (available from Sony, Inc.), Google Glass (available from Google, Inc.), Moverio BT-200 (available from Epson, Inc.), Recon Jet (available from Recon Instruments, Inc.), Vuzix M100 (available from Vuzix Corp.), etc.

In one or more embodiments, augmented reality can be displayed via a mobile computing device and/or a display device. In one example, augmented reality can be displayed via a tablet device (e.g. an iPad, a Gooble Nexus 7, etc.). In a second example, augmented reality can be displayed via a mobile smart phone and/or a media player (e.g. an iPhone, a Samsung Galaxy, an iPod, etc.). In another example, augmented reality can be displayed via a smart watch (e.g., an iWatch, a Motorola Moto 360, a Samsung Gear 2, LG G Watch, etc.).

In one or more embodiments, AR device 2112 can include one or more hardware components. For example, AR device 2112 can include one or more of a processor, sensors (e.g., image sensor(s), camera(s), accelerometer(s), gyroscope(s), GPS receiver, solid state compass, etc.), a display, and input devices, among others. In one instance, AR device 2112 can include one or more structures and/or functionalities as those described with reference to HMD 212. In a second instance, AR device 2112 can be or include a tablet computing device and/or a smart device (e.g., a smart phone, a smart music player, a personal digital assistant, etc.), among others. In a third instance, AR device 2112, as illustrated in FIG. 21A, can be or include one or more of eyeglasses and a head up display (HUD), among others. In another instance, AR device 2112 can be or include contact lenses that can provide and/or present one or more AR images to user 250.

In one or more embodiments, AR can be or include a view (e.g., direct, indirect, etc.) of a physical environment, where one or more elements of the physical environment are augmented by computing device output. For example, the computing device output can include one or more of sound, video, graphics, and physical stimulus (e.g., providing physical stimulus to a human being such as user 250), among others. For instance, an interaction of user 250 with the physical environment can be modified by the computing device output. In one or more embodiments, the computing device output in an AR experience can function to enhance a user's perception of reality.

In one or more embodiments, AR can include one or more user experiences in semantic context with environmental elements, such as shopping, walking down a street, viewing a video, viewing a picture, etc. For example, information associated with the real world of the user can be interactive and/or digitally manipulated via one or more computing devices. For instance, augmented and/or artificial information associated with a physical environment and its elements can be overlaid.

As illustrated, a physical environment can include a physical store 2100. As shown, physical store 2100 can include elements 2120-2128. For example, elements 2120-2128 can be or include items for sale or for rent.

In one or more embodiments, AR device 2112 can display information based on a user's interaction with one or more of elements 2120-2128. In one example, user 250 can interact with women's shoe 2126, and AR device 2112 can display information associated with one or more of women's shoe 2126 and women's purse 2122, among others. In one instance, AR device 2112 can display information associated with women's shoe 2126 (e.g., price, manufacture information, model information, material information, endorsement information, a uniform resource locator (URL), a uniform resource identifier (URI), a picture of another wearing the shoe, etc.). In another instance, AR device 2112 can display one or more of a picture of women's purse 2122, a video (e.g., a motion picture) of women's purse 2122, and directions and/or a path through physical store 2100 to arrive at women's purse 2122.

In another example, user 250 can interact with device 2128, and AR device 2112 can display information associated with one or more of device 2128, athletic shoe 2124, and women's purse 2122, among others. In one instance, AR device 2112 can display one or more of a service plan (e.g., a wireless telephone service plan), a URL associated with device 2128, a URI associated with device 2128, a media capacity, and a battery life, among others. In a second instance, AR device 2112 can display one or more of a picture of athletic shoe 2124, a video (e.g., a motion picture) of athletic shoe 2124, and directions and/or a path through physical store 2100 to arrive at athletic shoe 2124. In another instance, AR device 2112 can display one or more of a picture of a place to store device 2128 within women's purse 2122, a URL associated with women's purse 2122, a URI associated with women's purse 2122, a video (e.g., a motion picture) of women's purse 2122, and directions and/or a path through physical store 2100 to arrive at women's purse 2122.

Turning now to FIGS. 22A and 22B, a method providing an augmented reality shopping experience to a customer is provided, according to one or more embodiments. At 2205, a detection can be made. In one or more embodiments, the detection can include one or more of detecting an identification badge, detecting a code, detecting a graphic, and detecting a logo, among others. In one example, a detection of a radio frequency identification (RFID) can be made. For instance, the RFID detection can indicate one or more of a product, a product ID, a product description, a URL, a URI, and a product manufacturer, among others. In a second example, a detection of a code (e.g., a bar code, a two-dimensional bar code, a quick reference (QR) code, etc.) can be made. For instance, the code detection can indicate one or more of a product, a product ID, a product description, a URL, a URI, and a product manufacturer, among others.

In one or more embodiments, one or more of computer vision and optical character recognition (OCR), among others, can be utilized in detecting a graphic and/or a logo. In one example, computer vision can be utilized to detect one or more trademarks and/or one or more service marks. For instance, a logo and/or graphic 2134, illustrated in FIGS. 21B and 22B, of element 2124 (e.g., athletic shoe) of the physical environment (e.g., physical store 2100) can be detected. In a second example, lettering on a product or on a packaging of a product can be detected via OCR. In another example, OCR can be utilized to identify an object via a database of available objects. For instance, the identified object can be utilized as a detection key.

At 2210, it can be determined if a customer profile is available. In one or more embodiments, determining if a customer profile is available can include accessing a database. In one example, one or more of DBs 24230-24232 (FIG. 24) can accessed to determine if a customer profile is available. In another example, a local database of AR device 2112 24230-24232 (FIG. 24) can accessed to determine if a customer profile is available.

If a customer profile is available, profile information can be retrieved at 2215. In one example, the profile information can be retrieved from one or more of DBs 24230-24232. In another example, the profile information can be retrieved from a local database of AR device 2112.

At 2220, a presentation based on profile information of the customer profile can be created and/or optimized. For example, a presentation of physical store 2100, its elements, and/or information associated with its elements can be created and/or optimized based on profile information of the customer profile of user 250.

In one instance, the presentation can include one or more of pricing information, manufacture information, model information, material information, endorsement information, a URL, a URI, a product suggestion, a picture, and a video, among others, which can be presented to user 250 via AR device 2112. In a second instance, the profile information associated with user 250 can indicate that user 250 is a female, and the presentation can direct user 250 to products associated with women. In another instance, the presentation can be created and/or optimized based on one or more of a sport, a yearly income, an automobile type, a means of payment (e.g., credit card and/or billing information), an address, a marital status, a credit history, a past transaction, a past purchase, a music genre, an interest, an employment status, an age, a height, a weight, a hair color, an eye color, a shoe size, a dress size, a waist size, an inseam size, a breast size, a chest size, and a membership, among others.

If a customer profile is not available, a presentation based on previous users' information, at 2240. For example, the presentation can be created and/or optimized based previous customers' buying patterns. At 2225, the presentation can be provided to the user. For example, the presentation can be provided to user 250 via AR device 2112.

At 2230, user input can be received. In one example, user input from customer 250 that selects an item can be received. In another example, user input from customer 250 that requests assistance can be received. In one or more embodiments, user input from customer 250 can be or include passive input. For example, a timer can measure one or more amounts of time transpiring that can indicate one or more amounts of time that user 250 spends at one or more locations, spends with one or more items, and/or spends traversing one or more paths.

At 2235, the user input can be stored. In one example, the user input can be stored via one or more of DBs 24230-24232. In another example, the user input can be stored via an event tracking database of AR device 2112.

At 2245, a response to the user input can be determined. If the user input indicates that assistance is requested, assistance can be provided at 2260. For example, user 250 can receive assistance from a person 218 (FIG. 23B) via AR device 2112. If no item is selected, it can be determined if further presentations are to be continued at 2250. If further presentations are to be continued, the method can proceed to 2225. If further items and/or layouts are not to be continued, the method can conclude at 2255.

With reference again to 2245, if the user input indicates that an item is selected, an “add to cart” feature can be provided at 2265. At 2270, user input can be received, and the user input can be stored at 2275. At 2280, it can be determined if the user input indicates that the user would like to purchase the item. In one example, user 250 can select, via AR device 2112, a “proceed to checkout” option to indicate that user 250 would like to purchase the item. In another example, user 250 can deselect the item to indicate that user 250 would not like to purchase the item.

If the user input indicates that the user would like to purchase the item, checkout/settlement options can be provided to the user at 2285. For example, the checkout/settlement options provided to the user can include one or more of a cost of the item, a tax on the item, a delivery cost for the item, a delivery time for the item, a delivery option for the item, a pickup option for the item, a “pay and take it” option, and a compensation option, among others.

At 2290, compensation can be received. In one example, compensation can be received via a funds transfer. In one instance, the funds transfer can include debiting a credit card or a debit card of user 250. In another instance, the funds transfer can include debiting an account (e.g., a bank account, an accrual bill, etc.). In a second example, compensation can be received via a collect on delivery post process. In another example, compensation can be received via an in store pickup process. For instance, the in store pickup process can include receiving compensation via cash and/or debiting an account associated with user 250. In one or more embodiments, method elements can be performed in varying orders. For example, element 2290 can be performed to accommodate and/or coordinate with an in store pickup process and/or a collect on delivery post process, among others.

At 2292, a transaction can be stored. For example, the transaction associated with purchasing and/or receiving the selected item can be stored. For instance, the transaction can be stored via one or more of DBs 24230-24232 (FIG. 24). At 2294, the transaction can be processed. For example, processing the transaction can include one or more of debiting an account associated with user 250, providing item and/or delivery information to a warehouse and/or a shipping company/service, and providing the item to user 250 via a network (e.g., network 24010), among others. In one or more embodiments, an item can be or include instructions executable by a processor (e.g., software, firmware, etc.) and/or data (e.g., one or more music files, one or more video files, one or more motion pictures, one or more pictures, one or more pass codes, one or more license keys, one or more vouchers, one or more video streams, one or more live video feeds, one or more electronic books (ebooks), one or more electronic magazines (emagazines), one or more electronic newspapers (enewspapers), etc.), and processing the transaction can include providing the item to one or more of a device of user 250 via a network (e.g., network 24010) and a device of another user via a network (e.g., network 24010), among others.

At 2296, a presentation can be optimized based on one or more of transaction information, previous users' information, and profile information of the user (e.g., user/customer 250), among others. In one or more embodiments, a presentation can be optimized based on one or more inferences determined by artificial intelligence system 1810 (illustrated in FIG. 18).

In one or more embodiments, a presentation can be optimized based on the transaction associated with one or more of method elements 2285-2294. In one example, the transaction can include a valued item. For instance, the presentation can be optimized, based on the value item, to include one or more other items that are similarly valued. In a second example, the transaction can be associated with one or more of a sport, a gender, an automobile type, a marital status, a music genre, an interest, an age, a height, a weight, a hair color, an eye color, a shoe size, a dress size, a waist size, an inseam size, a breast size, a chest size, and a membership, among others. For instance, the presentation can be optimized based on the one or more of the sport, the gender, the automobile type, the marital status, the music genre, the interest, the age, the height, the weight, the hair color, the eye color, the shoe size, the dress size, the waist size, the inseam size, the breast size, the chest size, and the membership, among others. In one or more embodiments, the method can proceed to 2225.

With reference again to method element 2280, if the user input indicates that the user would not like to purchase the item, a coupon/discount can be provided at 2298. In one example, the coupon/discount can be provided for the item, via AR device 2112. In another example, the coupon/discount can be provided, via AR device 2112, for another item that is similar and/or related to the item that the user did not desire to purchase. In one or more embodiments, the method can proceed to 2250.

Turning now to FIGS. 23A and 23B, a further detailed aspect of virtual interaction with a live person via a HMD or an AR device is illustrated, according to one or more embodiments. As shown, one or more cameras 234 and 236 can be configured at different angles of exposure. In one or more embodiments, utilizing multiple cameras at different angles of exposure can be included in a method, process, and/or system of producing a stereoscopic display and/or view for a customer (e.g., user 250). For example, utilizing cameras 234 and 236 at different angles of exposure can be utilized in a method, process, and/or system of producing a stereoscopic display and/or view of a person 218 for customer 250. For instance, person 218 can be one or more of a representative of a retailer, a sales representative, a service representative, a leasing agent, and a repair representative, among others.

In one or more embodiments, person 218 can interact with one or more of the virtual environment and with devices that customer 250 is interacting, among others. In another example, utilizing cameras 234 and 236 at different angles of exposure can be utilized in a method, process, and/or system of producing a stereoscopic display and/or view of customer 250. In one or more embodiments, customer 250 can be shown in the virtual environment interacting with one or more of the virtual environment and with devices or items (e.g., clothes) that customer 250 is interacting with, among others.

As illustrated in FIG. 23A, cameras 234 and 236 can be coupled to HMD 212. As shown in FIG. 23B, cameras 234 and 236 can be coupled to AR device 2112. For example, cameras 234 and 236 can be coupled to HMD 212 and/or AR device 2112 via a network (e.g., network 24010). In one or more embodiments, video and audio outputs can be provided to HMD 212 and/or AR device 2112 in real-time. For example, customer 250 can view and/or interact with person 218 via video streams 260 and 262 that can be displayed via displays 370 and 371 (illustrated in FIG. 3), respectively. For instance, cameras 234 and 236 can capture images that can be utilized in producing video streams 260 and 262, respectively.

In one or more embodiments, person 218 can be an augmented and/or simulated reality substitute for a live person (e.g., an avatar of a person). For example, customer 250 can interact with the simulated person and an object (e.g., the object for sale or for service) in a same or similar fashion as customer 250 would interact with a person (e.g., a human being), such as a customer service representative of a retail establishment. For instance, the simulated person can be configured to demonstrate one or more aspects, configurations, and/or features of the object and can be configured with information associated with a profile of customer 250 to represent the one or more aspects, configurations, and/or features of the object that are associated with the profile of customer 250.

Turning now to FIG. 24, a block diagram of a network communication system is illustrated, according to one or more embodiments. As illustrated, one or more customer computing devices (CCDs) 24110-24114 can be coupled to a network 24010. In one or more embodiments, a customer computing device (CCD) can be, include, or be coupled to a HMD and/or an AR device. For example, CCD 24110 can be, include, or be coupled to HMD 212 and/or AR device 2112.

In one or more embodiments, network 24010 can include one or more of a wireless network and a wired network. Network 24010 can be coupled to one or more types of communications networks, such as one or more of a public switched telephone network (PSTN), a public wide area network (e.g., an Internet), a private wide area network, and a local area network, among others. In one example, network 24010 can be or include an Internet. In another example, network 24010 can form part of an Internet. In one or more embodiments, one or more of CCDs 24110-1114 can be coupled to network 24010 via a wired communication coupling and/or a wireless communication coupling. In one example, a CCD can be coupled to network 24010 via wired Ethernet, a DSL (digital subscriber loop) modem, or a cable (television) modem, among others. In another example, a CCD can be coupled to network 24010 via wireless Ethernet (e.g., WiFi), a satellite communication coupling, a mobile wireless telephone coupling, or WiMax, among others.

As shown, one or more media servers 24210-24212 can be coupled to network 24010, and media servers 24210-24212 can include media server interfaces 24220-24222, respectively. As illustrated, media servers 24210 and 24211 can be coupled to databases 24230 and 24231, and media server 24212 can include a database (DB) 24232. In one example, DB 24230 can be or include an Oracle database. In a second example, DB 24231 can be or include a Microsoft SQL Server database. In another example, DB 24232 can be or include a MySQL database or a PostgreSQL database. In another example, DB 24232 can be or include a noSQL Mongo, RIAC or Hadoop database. In one or more embodiments, databases 24230-24232 can be, include, or be coupled to an event tracking database. In one example, DB 24230 can be, include, or be coupled to event tracking database 230. In another example, DB 24232 can be, include, or be coupled to event tracking database 230.

In one or more embodiments, one or more of media server interfaces 24220-24222 can provide one or more computer system interfaces to one or more of CCDs 24110-24114. In one example, media server interface 24220 can include a web server. In another example, media server interface 24221 can include a server that interacts with a client application of a CCD. In one instance, the client application can include a “smart phone” application. In a second instance, the client application can include a tablet computing device application. In another instance, the client application can include a computing device application (e.g., an application for a desktop or laptop computing device).

In one or more embodiments, one or more of media server interfaces 24220-24222 can provide images and/or video streams to HMD 212. In one example, one or more of media server interfaces 24220-24222 can provide video streams 260 and 262 to HMD 212. In a second example, one or more of media server interfaces 24220-24222 can provide video streams 446 and 448 to HMD 212. In another example, one or more of media server interfaces 24220-24222 can provide one or more presentations to AR device 2112.

As illustrated, one or more customer service devices (CSDs) 24310-24312 can be coupled to network 24010. In one or more embodiments, a service representative (e.g., a customer service representative of a retail establishment, a service representative of a service provider, etc.) can utilize a customer service device (CSD) to interact with a customer utilizing a CCD. For example, the service representative can utilize the CSD to provide information to the customer via the CCD. In one instance, the service representative can utilize the CSD to conduct one or more of a video chat, a text chat, and an audio chat. In a second instance, the service representative can utilize the CSD to illustrate and/or demonstrate one or more features and/or operations of an object for sale or of an object for which service is desired by the customer.

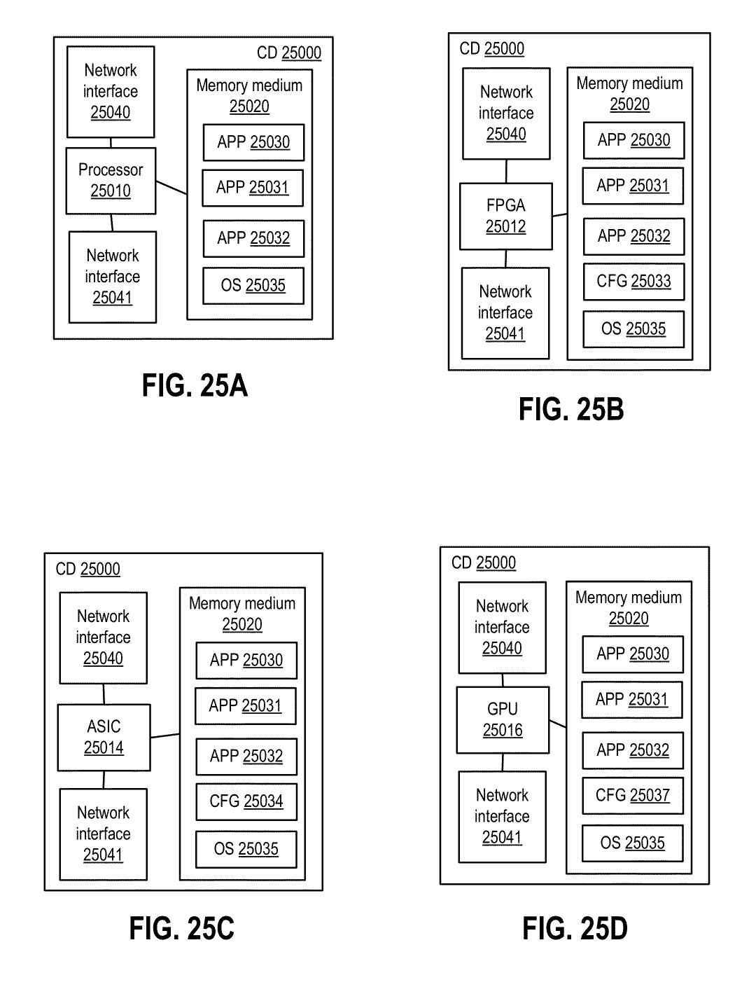

Turning now to FIG. 25A, a computing device is illustrated, according to one or more embodiments. In one or more embodiments, computing device (CD) 25000 illustrated in FIGS. 25A-25D can be utilized to implement a CCD, a HMD, an AR device, and/or a CSD. For example, a CCD, a HMD, and/or a CSD can include one or more structures and/or functionalities as those described with reference to CD 25000.

As shown, CD 25000 can include a processor 25010 coupled to a memory medium 25020. In one or more embodiments, memory medium 25020 can store data and/or instructions that can be executed by processor 25010. For example, memory medium 2020 can store one or more APPs 25030-25032 and/or an OS 25035. For instance, one or more APPs 25030-25032 and/or an OS 25035 can include instructions of an ISA associated with processor 25010. In one or more embodiments, CD 25000 can be coupled to and/or include one or more of a display, a keyboard, and a pointing device (e.g., a mouse, a track ball, a track pad, a stylus, etc.). In one or more embodiments, a touch screen can function as a pointing device. In one example, the touch screen can determine a position via one or more pressure sensors. In another example, the touch screen can determine a position via one or more capacitive sensors.

As illustrated, CD 25000 can include one or more network interfaces 25040 and 25041. In one example, network interface 25040 can interface with a wired network coupling, such as a wired Ethernet, a T-1, a DSL modem, a PSTN, or a cable modem, among others. In another example, network interface 341 can interface with a wireless network coupling, such as a satellite telephone system, a mobile wireless telephone system (e.g., one or more of a satellite telephone system, a cellular telephone system, etc.), WiMax, WiFi, or wireless Ethernet, among others.

In one or more embodiments, CD 25000 can be any of various types of devices, including a computer system, a server computer system, a laptop computer system, a notebook computing device, a portable computer, a PDA, a handheld mobile computing device, a mobile wireless telephone (e.g., a satellite telephone, a cellular telephone, etc.), an Internet appliance, a television device, a DVD (digital video disc player) device, a Blu-Ray disc player device, a DVR (digital video recorder) device, a wearable computing device, or other wireless or wired device that includes a processor that executes instructions from a memory medium. In one or more embodiments, processor 2010 can include one or more cores. For example, each core of processor 2010 can implement an ISA. In one or more embodiments, one or more of CCDs 24110-24114, media servers 24210-24212, databases 24230 and 24231, and CSDs 24310-24312 can include one or more same or similar structures and/or functionalities described with reference to CD 25000.

Turning now to FIG. 25B, a computing device is illustrated, according to one or more embodiments. As shown, CD 25000 can include a field programmable gate array (FPGA) 25012 coupled to a memory medium 25020. In one or more embodiments, memory medium 2020 can store data and/or configuration information that can be utilized by FPGA 25012 in implementing one or more systems, methods, and/or processes described herein. For example, memory medium 2020 can store a configuration (CFG) 25033, and CFG 25033 can include configuration information and/or one or more instructions that can be utilized by FPGA 25012 to implement one or more systems, methods, and/or processes described herein. For instance, the configuration information and/or the one or more instructions, of CFG 25033, can include a hardware description language and/or a schematic design that can be utilized by FPGA 25012 to implement one or more systems, methods, and/or processes described herein. In one or more embodiments, FPGA 25012 can include multiple programmable logic components that can be configured and coupled to one another in implementing one or more systems, methods, and/or processes described herein.

In one or more embodiments, memory medium 25020 can store data and/or instructions that can be executed by FPGA 25012. For example, memory medium 25020 can store one or more APPs 2030-332 and/or an OS 25035. For instance, one or more APPs 25030-25032 and/or an OS 25035 can include instructions of an ISA associated with FPGA 25012. In one or more embodiments, CD 25000 can be coupled to and/or include one or more of a display, a keyboard, and a pointing device (e.g., a mouse, a track ball, a track pad, a stylus, etc.). In one or more embodiments, a touch screen can function as a pointing device. In one example, the touch screen can determine a position via one or more pressure sensors. In another example, the touch screen can determine a position via one or more capacitive sensors.

As illustrated, CD 25000 can include one or more network interfaces 25040 and 25041. In one example, network interface 2040 can interface with a wired network coupling, such as a wired Ethernet, a T-1, a DSL modem, a PSTN, or a cable modem, among others. In another example, network interface 2041 can interface with a wireless network coupling, such as a satellite telephone system, a cellular telephone system, WiMax, WiFi, or wireless Ethernet, among others.

In one or more embodiments, CD 25000 can be any of various types of devices, including a computer system, a server computer system, a laptop computer system, a notebook computing device, a portable computer, a PDA, a handheld mobile computing device, a mobile wireless telephone (e.g., a satellite telephone, a cellular telephone, etc.), an Internet appliance, a television device, a DVD device, a Blu-Ray disc player device, a DVR device, a wearable computing device, or other wireless or wired device that includes a FPGA that processes data according to one or more methods and/or processes described herein. In one or more embodiments, one or more of CCDs 24110-24114, media servers 24210-24212, databases 24230 and 24231, and CSDs 24310-24312 can include one or more same or similar structures and/or functionalities described with reference to CD 25000.

Turning now to FIG. 25C, a computing device is illustrated, according to one or more embodiments. As shown, CD 25000 can include an application specific processor (ASIC) 25014 coupled to a memory medium 25020. In one or more embodiments, memory medium 25020 can store data and/or configuration information that can be utilized by ASIC 25014 in implementing one or more systems, methods, and/or processes described herein. For example, memory medium 25020 can store a CFG 25034, and CFG 25034 can include configuration information and/or one or more instructions that can be utilized by ASIC 25014 to implement one or more systems, methods, and/or processes described herein.

In one or more embodiments, memory medium 25020 can store data and/or instructions that can be executed by ASIC 25014. For example, memory medium 25020 can store one or more APPs 25030-25032 and/or an OS 25035. For instance, one or more APPs 25030-25032 and/or an OS 25035 can include instructions of an ISA associated with ASIC 25014. In one or more embodiments, CD 25000 can be coupled to and/or include one or more of a display, a keyboard, and a pointing device (e.g., a mouse, a track ball, a track pad, a stylus, etc.). In one or more embodiments, a touch screen can function as a pointing device. In one example, the touch screen can determine a position via one or more pressure sensors. In another example, the touch screen can determine a position via one or more capacitive sensors.

As illustrated, CD 25000 can include one or more network interfaces 25040 and 25041. In one example, network interface 2040 can interface with a wired network coupling, such as a wired Ethernet, a T-1, a DSL modem, a PSTN, or a cable modem, among others. In another example, network interface 2041 can interface with a wireless network coupling, such as a satellite telephone system, a mobile wireless telephone system, WiMax, WiFi, or wireless Ethernet, among others.

In one or more embodiments, CD 25000 can be any of various types of devices, including a computer system, a server computer system, a laptop computer system, a notebook computing device, a portable computer, a PDA, a handheld mobile computing device, a mobile wireless telephone (e.g., a satellite telephone, a cellular telephone, etc.), an Internet appliance, a television device, a DVD device, a Blu-Ray disc player device, a DVR device, a wearable computing device, or other wireless or wired device that includes ASIC that processes data according to one or more methods and/or processes described herein. In one or more embodiments, one or more of CCDs 24110-24114, media servers 24210-24212, databases 24230 and 24231, and CSDs 24310-24312 can include one or more same or similar structures and/or functionalities described with reference to CD 25000.

Turning now to FIG. 25D, a computing device is illustrated, according to one or more embodiments. As shown, CD 25000 can include graphics processing unit (GPU) 25016 coupled to a memory medium 25020. For example, GPU 25016 can be or include a general purpose graphics processing unit (GPGPU). In one or more embodiments, memory medium 25020 can store data and/or configuration information that can be utilized by GPU 25016 in implementing one or more systems, methods, and/or processes described herein. For example, memory medium 25020 can store a CFG 25037, and CFG 25037 can include configuration information and/or one or more instructions that can be utilized by GPU 25016 to implement one or more systems, methods, and/or processes described herein.

In one or more embodiments, memory medium 25020 can store data and/or instructions that can be executed by GPU 25016. For example, memory medium 2020 can store one or more APPs 25030-25032 and/or an OS 25035. For instance, one or more APPs 25030-25032 and/or an OS 25035 can include instructions of an ISA associated with GPU 25016. In one or more embodiments, CD 25000 can be coupled to and/or include one or more of a display, a keyboard, and a pointing device (e.g., a mouse, a track ball, a track pad, a stylus, etc.). In one or more embodiments, a touch screen can function as a pointing device. In one example, the touch screen can determine a position via one or more pressure sensors. In another example, the touch screen can determine a position via one or more capacitive sensors.

As illustrated, CD 25000 can include one or more network interfaces 25040 and 25041. In one example, network interface 25040 can interface with a wired network coupling, such as a wired Ethernet, a T-1, a DSL modem, a PSTN, or a cable modem, among others. In another example, network interface 2041 can interface with a wireless network coupling, such as a satellite telephone system, a mobile telephone system, WiMax, WiFi, or wireless Ethernet, among others.

In one or more embodiments, CD 25000 can be any of various types of devices, including a computer system, a server computer system, a laptop computer system, a notebook computing device, a portable computer, a PDA, a handheld mobile computing device, a mobile wireless telephone (e.g., a satellite telephone, a cellular telephone, etc.), an Internet appliance, a television device, a DVD device, a Blu-Ray disc player device, a DVR device, a wearable computing device, or other wireless or wired device that includes a GPU that processes data according to one or more methods and/or processes described herein. In one or more embodiments, one or more of CCDs 24110-24114, media servers 24210-1212, databases 24230 and 24231, and CSDs 24310-24312 can include one or more same or similar structures and/or functionalities described with reference to CD 25000.

In one or more embodiments, the term “memory medium” can mean a “memory”, a “memory device”, and/or “tangible computer readable storage medium”. In one example, one or more of a “memory”, a “memory device”, and “tangible computer readable storage medium” can include volatile storage such as SRAM, DRAM, Rambus RAM, EDO RAM, random access memory, etc. In another example, one or more of a “memory”, a “memory device”, and “tangible computer readable storage medium” can include nonvolatile storage such as a CD-ROM, a DVD-ROM, a floppy disk, a magnetic tape, EEPROM, EPROM, flash memory, NVRAM, FRAM, a magnetic media (e.g., a hard drive), optical storage, etc. In one or more embodiments, a memory medium can include one or more volatile storages and/or one or more nonvolatile storages.

In one or more embodiments, a computer system, a computing device, and/or a computer can be broadly characterized to include any device that includes a processor that executes instructions from a memory medium. For example, a processor (e.g., a central processing unit or CPU) can execute instructions from a memory medium that stores the instructions which can include one or more software programs in accordance with one or more of methods and/or processes described herein. For instance, the processor and the memory medium, that stores the instructions which can include one or more software programs in accordance with one or more of methods and/or processes described herein, can form one or more means for one or more functionalities described with references to methods and/or processes described herein. In one or more embodiments, a memory medium can be and/or can include an article of manufacture, a program product, and/or a software product. For example, the memory medium can be coded and/or encoded with instructions in accordance with one or more of methods and/or processes described herein to produce an article of manufacture, a program product, and/or a software product.

One or more of method elements described herein and/or one or more portions of an implementation of a method element can be repeated, can be performed in varying orders, can be performed concurrently with one or more of the other method elements and/or one or more portions of an implementation of a method element, or can be omitted, according to one or more embodiments. In one or more embodiments, concurrently can mean simultaneously. In one or more embodiments, concurrently can mean apparently simultaneously according to some metric. For example, two tasks can be context switched such that such that they appear to be simultaneous to a human. In one instance, a first task of the two tasks can include a first method element and/or a first portion of a first method element. In a second instance, a second task of the two tasks can include a second method element and/or a first portion of a second method element. In another instance, a second task of the two tasks can include the first method element and/or a second portion of the first method element. Further, one or more of the system elements described herein can be omitted and additional system elements can be added as desired, according to one or more embodiments. Moreover, supplementary, additional, and/or duplicated method elements can be instantiated and/or performed as desired, according to one or more embodiments.

While one or more embodiments may be susceptible to various modifications and alternative forms, specific embodiments thereof are shown by way of example in the drawings and have herein been described in detail. It should be understood, however, that the drawings and detailed description thereto are not intended to limit the disclosure to the particular form disclosed, but on the contrary, the disclosure is to cover all modifications, equivalents and alternatives falling within the spirit and scope of this disclosure.

One or more modifications and/or alternatives of the embodiments described herein may be apparent to those skilled in the art in view of this description. Hence, descriptions of the embodiments, described herein, are to be taken and/or construed as illustrative and/or exemplary only and are for the purpose of teaching those skilled in the art a general manner. In one or more embodiments, one or more materials and/or elements can be swapped or substituted for those illustrated and described herein. In one or more embodiments, one or more parts and/or processes can be reversed, and/or certain one or more features of the described one or more embodiments can be utilized independently, as would be apparent to one skilled in the art after having the benefit of this description.

What is claimed is:

1. A system, comprising:
a processor; and
a memory, coupled to the processor, that includes instructions executable by the processor;
wherein when the processor executes the instructions, the system:
receives first user input from multiple users that indicates at least one of a selection of a first item and a path through a first three-dimensional layout of a three-dimensional virtual store;
stores the first user input from the multiple users;
infers, based on the first user input from the multiple users, a second item, different from the first item;
modifies a second three-dimensional layout to include the second item; and
provides the second three-dimensional layout to a user.

2. The system of claim 1, wherein the system further:
receives second user input from the user that indicates at least a selection of the second item;
infers, based on the first user input from the multiple users and the second user input, a third item, different from the first item and different from the second item;
modifies the second three-dimensional layout to include the third item; and
provides the second three-dimensional layout, including the third item, to the user.

3. The system of claim 1, wherein the system further:
receives second user input from the user that indicates at least a selection of the second item;
infers, based on the first user input from the multiple users and the second user input, a third item, different from the first item and different from the second item, wherein the inferring, based on the first user input from the multiple users and the second user input, the third item produces a first number;
determines that the first number is below a threshold;
infers, based on the first user input from the multiple users and the second user input, a fourth item, different from the first item, different from the second item, and different from the third item, wherein when the system infers, based on the first user input from the multiple users and the second user input, the fourth item, the system produces a second number;
determines that the second number is at or above the threshold;
in response to determining that the second number is at or above the threshold, modifies the second three-dimensional layout to include the fourth item; and
provides the second three-dimensional layout, including the fourth item, to the user.

4. The system of claim 1, wherein when the system infers, based on the first user input from the multiple users, the second item, different from the first item, the system utilizes multiple rules that match the first user input.

5. The system of claim 1, wherein when the system infers, based on the first user input from the multiple users, the second item, different from the first item, the system utilizes Bayesian inference.

6. The system of claim 1,
wherein when the system infers, based on the first user input from the multiple users, the second item, different from the first item, the system produces a number;
wherein the system further determines that the number is at or above a threshold;
wherein the system modifies the second three-dimensional layout to include the second item in response to determining that the number is at or above the threshold.

7. The system of claim 1, wherein the system further:
receives second user input from the user that indicates a selection of the second item; and
in response to receiving the second user input from the user that indicates the selection of the second item, presents an option of purchasing the second item.

8. The system of claim 1, wherein when the systems provides the second three-dimensional layout to the user, the system provides the second three-dimensional layout to the user via a network.

9. The system of claim 8, wherein the network includes a wide area network.

10. The system of claim 9, wherein the wide area network includes an Internet.

11. The system of claim 1, wherein the second three-dimensional layout is different from the first three-dimensional layout.

12. The system of claim 1, wherein the first user input from the multiple users further indicates one or more of a sport, a gender, a yearly income, an automobile type, a means of payment, an address, a marital status, a credit history, a past transaction, a past purchase, a music genre, an interest, an employment status, an age, a height, a weight, a hair color, an eye color, a shoe size, a dress size, a waist size, an inseam size, a breast size, a chest size, and a membership.

13. The system of claim 1, wherein when the system stores the first user input from the multiple users, the system stores the first user input from the multiple users via at least one database.

14. A computer readable memory device that includes instructions, which when executed by a processor of a processing system, the processing system:
receives first user input from multiple users that indicates at least one of a selection of a first item and a path through a first three-dimensional layout of a three-dimensional virtual store;
stores the first user input from the multiple users;
infers, based on the first user input from the multiple users, a second item, different from the first item;
modifies a second three-dimensional layout to include the second item; and
provides the second three-dimensional layout to a user.

15. The computer readable memory device of claim 14, wherein the processing system further:
receives second user input from the user that indicates at least a selection of the second item;
infers, based on the first user input from the multiple users and the second user input, a third item, different from the first item and different from the second item;
modifies the second three-dimensional layout to include the third item; and
provides the second three-dimensional layout, including the third item, to the user.

16. The computer readable memory device of claim 15, wherein the processing system further:
receives second user input from the user that indicates at least a selection of the second item;
infers, based on the first user input from the multiple users and the second user input, a third item, different from the first item and different from the second item, wherein when the processing system infers, based on the first user input from the multiple users and the second user input, the third item, the processing system produces a first number;
determines that the first number is below a threshold;
infers, based on the first user input from the multiple users and the second user input, a fourth item, different from the first item, different from the second item, and different from the third item, wherein when the data processing system infers, based on the first user input from the multiple users and the second user input, the fourth item, the processing system produces a second number;
determines that the second number is at or above the threshold;
in response to determining that the second number is at or above the threshold, modifies the second three-dimensional layout to include the fourth item; and
provides the second three-dimensional layout, including the fourth item, to the user.

17. The computer readable memory device of claim 14, wherein when the processing system infers, based on the first user input from the multiple users, the second item, different from the first item, the processing system utilizes multiple rules that match the first user input.

18. The computer readable memory device of claim 14, wherein when the processing system infers, based on the first user input from the multiple users, the second item, different from the first item, the processing system utilizes Bayesian inference.

19. The computer readable memory device of claim 14,
wherein when the processing system infers, based on the first user input from the multiple users, the second item, different from the first item, the processing system produces a number;
wherein the processing system further determines that the number is at or above a threshold;
wherein the processing system modifies the second three-dimensional layout to include the second item in response to determining that the number is at or above the threshold.

20. The computer readable memory device of claim 14, wherein the processing system further:
receives second user input from the user that indicates a selection of the second item; and
in response to receiving the second user input from the user that indicates the selection of the second item, presents an option of purchasing the second item.

21. The computer readable memory device of claim 14, wherein when the processing systems provides the second three-dimensional layout to the user, the processing system provides the second three-dimensional layout to the user via a network.

22. The computer readable memory device of claim 21, wherein the network includes a wide area network.

23. The computer readable memory device of claim 22, wherein the wide area network includes an Internet.

24. The computer readable memory device of claim 14, wherein the second three-dimensional layout is different from the first three-dimensional layout.

25. The computer readable memory device of claim 14, wherein the first user input from the multiple users further indicates one or more of a sport, a gender, a yearly income, an automobile type, a means of payment, an address, a marital status, a credit history, a past transaction, a past purchase, a music genre, an interest, an employment status, an age, a height, a weight, a hair color, an eye color, a shoe size, a dress size, a waist size, an inseam size, a breast size, a chest size, and a membership.

26. The computer readable memory device of claim 14, wherein when the processing system stores the first user input from the multiple users, the processing system stores the first user input from the multiple users via at least one database.

27. A method, comprising:
receiving first user input from multiple users that indicates at least one of a selection of a first item and a path through a first three-dimensional layout of a three-dimensional virtual store;
storing the first user input from the multiple users;
inferring, based on the first user input from the multiple users, a second item, different from the first item;
modifying a second three-dimensional layout to include the second item; and
providing the second three-dimensional layout to a user.

28. The method of claim 27, further comprising:
receiving second user input from the user that indicates at least a selection of the second item;
inferring, based on the first user input from the multiple users and the second user input, a third item, different from the first item and different from the second item;
modifying the second three-dimensional layout to include the third item; and
providing the second three-dimensional layout, including the third item, to the user.

29. The method of claim 27, further comprising:
receiving second user input from the user that indicates at least a selection of the second item;
inferring, based on the first user input from the multiple users and the second user input, a third item, different from the first item and different from the second item, wherein the inferring, based on the first user input from the multiple users and the second user input, the third item produces a first number;
determining that the first number is below a threshold;
inferring, based on the first user input from the multiple users and the second user input, a fourth item, different from the first item, different from the second item, and different from the third item, wherein the inferring, based on the first user input from the multiple users and the second user input, the fourth item produces a second number;
determining that the second number is at or above the threshold;
in response to the determining that the second number is at or above the threshold, modifying the second three-dimensional layout to include the fourth item; and
providing the second three-dimensional layout, including the fourth item, to the user.

30. The method of claim 27, wherein the inferring, based on the first user input from the multiple users, the second item, different from the first item includes utilizing multiple rules that match the first user input.

31. The method of claim 27, wherein the inferring, based on the first user input from the multiple users, the second item, different from the first item includes utilizing Bayesian inference.

32. The method of claim 27, wherein the inferring, based on the first user input from the multiple users, the second item, different from the first item produces a number;
the method further comprising:
determining that the number is at or above a threshold;
wherein the modifying the second three-dimensional layout to include the second item is performed in response to the determining that the number is at or above the threshold.

33. The method of claim 27, further comprising:
receiving second user input from the user that indicates a selection of the second item; and
in response to the receiving the second user input from the user that indicates the selection of the second item, presenting an option of purchasing the second item.

34. The method of claim 27, wherein the providing the second three-dimensional layout to the user includes providing the second three-dimensional layout to the user via a network.

35. The method of claim 34, wherein the network includes a wide area network.

36. The method of claim 35, wherein the wide area network includes an Internet.

37. The method of claim 27, wherein the second three-dimensional layout is different from the first three-dimensional layout.

38. The method of claim 27, wherein the first user input from the multiple users further indicates one or more of a sport, a gender, a yearly income, an automobile type, a means of payment, an address, a marital status, a credit history, a past transaction, a past purchase, a music genre, an interest, an employment status, an age, a height, a weight, a hair color, an eye color, a shoe size, a dress size, a waist size, an inseam size, a breast size, a chest size, and a membership.

39. The method of claim 27, wherein the storing the first user input from the multiple users includes the storing the first user input from the multiple users via at least one database.

40. A system, comprising:
means for receiving first user input from multiple users that indicates at least one of a selection of a first item and a path through a first three-dimensional layout of a three-dimensional virtual store;
means for storing the first user input from the multiple users;
means for inferring, based on the first user input from the multiple users, a second item, different from the first item;
means for modifying a second three-dimensional layout to include the second item; and
means for providing the second three-dimensional layout to a user.

41. The system of claim 40, further comprising:
means for receiving second user input from the user that indicates at least a selection of the second item;
means for inferring, based on the first user input from the multiple users and the second user input, a third item, different from the first item and different from the second item;
means for modifying the second three-dimensional layout to include the third item; and
means for providing the second three-dimensional layout, including the third item, to the user.

42. The system of claim 40, further comprising:
means for receiving second user input from the user that indicates at least a selection of the second item;
means for inferring, based on the first user input from the multiple users and the second user input, a third item, different from the first item and different from the second item, wherein the means for inferring, based on the first user input from the multiple users and the second user input, the third item produces a first number;
means for determining that the first number is below a threshold;
means for inferring, based on the first user input from the multiple users and the second user input, a fourth item, different from the first item, different from the second item, and different from the third item, wherein the means for inferring, based on the first user input from the multiple users and the second user input, the fourth item produces a second number;
means for determining that the second number is at or above the threshold;
means for modifying the second three-dimensional layout to include the fourth item, in response to the determining that the second number is at or above the threshold; and
means for providing the second three-dimensional layout, including the fourth item, to the user.

43. The system of claim 40, wherein the means for inferring, based on the first user input from the multiple users, the second item, different from the first item include means for utilizing multiple rules that match the first user input.

44. The system of claim 40, wherein the means for inferring, based on the first user input from the multiple users, the second item, different from the first item include means for utilizing Bayesian inference.

45. The system of claim 40, wherein the means for inferring, based on the first user input from the multiple users, the second item, different from the first item produces a number;
the system further comprising:
means for determining that the number is at or above a threshold;
wherein the means for modifying the second three-dimensional layout to include the second item includes means for modifying the second three-dimensional layout to include the second item, in response to determining that the number is at or above the threshold.

46. The system of claim 40, further comprising:
means for receiving second user input from the user that indicates a selection of the second item; and
means for presenting an option of purchasing the second item, in response to receiving the second user input from the user that indicates the selection of the second item.

47. The system of claim 40, wherein the means for providing the second three-dimensional layout to the user include means for providing the second three-dimensional layout to the user via a network.

48. The system of claim 47, wherein the network includes a wide area network.

49. The system of claim 48, wherein the wide area network includes an Internet.

50. The system of claim 40, wherein the second three-dimensional layout is different from the first three-dimensional layout.

51. The system of claim 40, wherein the first user input from the multiple users further indicates one or more of a sport, a gender, a yearly income, an automobile type, a means of payment, an address, a marital status, a credit history, a past transaction, a past purchase, a music genre, an interest, an employment status, an age, a height, a weight, a hair color, an eye color, a shoe size, a dress size, a waist size, an inseam size, a breast size, a chest size, and a membership.

52. The system of claim 40, wherein the means for storing the first user input from the multiple users include means for storing the first user input from the multiple users via at least one database.

53. A system, comprising:
a processor; and
a memory, coupled to the processor, that includes instructions executable by the processor;
wherein when the processor executes the instructions, the system:
receives first user input from multiple users that indicates at least one of a selection of a first item and a path through a first layout of a physical store;
stores the first user input from the multiple users;
infers, based on the first user input from the multiple users, a second item, different from the first item; and
provides, to an augmented reality device of the user, at least one of a picture of the second item, a uniform resource locator (URL) associated with the second item, a uniform resource identifier (URI) associated with the second item, directions through the physical store to arrive at the second item, and a path through the physical store to arrive at the second item.

54. The system of claim 53, wherein the system further:
receives second user input from the user that indicates at least a selection of the second item;
infers, based on the first user input from the multiple users and the second user input, a third item, different from the first item and different from the second item; and
provides, to the augmented reality device of the user, at least one of a picture of the third item, a URL associated with the third item, a URI associated with the third item, directions through the physical store to arrive at the third item, and a path through the physical store to arrive at the third item.

55. The system of claim 53, wherein the system further:
receives second user input from the user that indicates at least a selection of the second item;
infers, based on the first user input from the multiple users and the second user input, a third item, different from the first item and different from the second item, wherein the inferring, based on the first user input from the multiple users and the second user input, the third item produces a first number;
determines that the first number is below a threshold;
infers, based on the first user input from the multiple users and the second user input, a fourth item, different from the first item, different from the second item, and different from the third item, wherein when the system infers, based on the first user input from the multiple users and the second user input, the fourth item, the system produces a second number;
determines that the second number is at or above the threshold;
in response to determining that the second number is at or above the threshold, provides, to the augmented reality device of the user, information associated with the fourth item.

55. The system of claim 53, wherein when the system infers, based on the first user input from the multiple users, the second item, different from the first item, the system utilizes multiple rules that match the first user input.

56. The system of claim 53, wherein when the system infers, based on the first user input from the multiple users, the second item, different from the first item, the system utilizes Bayesian inference.

57. The system of claim 53,
wherein when the system infers, based on the first user input from the multiple users, the second item, different from the first item, the system produces a number;
wherein the system further determines that the number is at or above a threshold;
wherein, in response to determining that the number is at or above the threshold, the system provides, to the augmented reality device of the user, the at least one of the picture of the second item, the URL associated with the second item, the URI associated with the second item, the directions through the physical store to arrive at the second item, and the path through the physical store to arrive at the second item.

58. The system of claim 53, wherein the system further:
receives second user input from the user that indicates a selection of the second item; and
in response to receiving the second user input from the user that indicates the selection of the second item, presents an option of purchasing the second item via the augmented reality device.

59. The system of claim 53, wherein when the systems provides, to the augmented reality device of the user, the at least one of the picture of the second item, the URL associated with the second item, the URI associated with the second item, the directions through the physical store to arrive at the second item, and the path through the physical store to arrive at the second item, the system provides, to the augmented reality device of the user, the at least one of the picture of the second item, the URL associated with the second item, the URI associated with the second item, the directions through the physical store to arrive at the second item, and the path through the physical store to arrive at the second item via a network.

60. The system of claim 59, wherein the network includes a wide area network.

61. The system of claim 60, wherein the wide area network includes an Internet.

62. The system of claim 53, wherein the first user input from the multiple users further indicates one or more of a sport, a gender, a yearly income, an automobile type, a means of payment, an address, a marital status, a credit history, a past transaction, a past purchase, a music genre, an interest, an employment status, an age, a height, a weight, a hair color, an eye color, a shoe size, a dress size, a waist size, an inseam size, a breast size, a chest size, and a membership.

63. The system of claim 53, wherein when the system stores the first user input from the multiple users, the system stores the first user input from the multiple users via at least one database.

64. A computer readable memory device that includes instructions, which when executed by a processor of a processing system, the processing system:
receives first user input from multiple users that indicates at least one of a selection of a first item and a path through a first layout of a physical store;
stores the first user input from the multiple users;
infers, based on the first user input from the multiple users, a second item, different from the first item; and
provides, to an augmented reality device of the user, at least one of a picture of the second item, a uniform resource locator (URL) associated with the second item, a uniform resource identifier (URI) associated with the second item, directions through the physical store to arrive at the second item, and a path through the physical store to arrive at the second item.

65. The computer readable memory device of claim 64, wherein the processing system further:
receives second user input from the user that indicates at least a selection of the second item;
infers, based on the first user input from the multiple users and the second user input, a third item, different from the first item and different from the second item; and
provides, to the augmented reality device of the user, at least one of a picture of the third item, a URL associated with the third item, a URI associated with the third item, directions through the physical store to arrive at the third item, and a path through the physical store to arrive at the third item.

66. The computer readable memory device of claim 64, wherein the processing system further:
receives second user input from the user that indicates at least a selection of the second item;
infers, based on the first user input from the multiple users and the second user input, a third item, different from the first item and different from the second item, wherein when the processing system infers, based on the first user input from the multiple users and the second user input, the third item, the processing system produces a first number;
determines that the first number is below a threshold;
infers, based on the first user input from the multiple users and the second user input, a fourth item, different from the first item, different from the second item, and different from the third item, wherein when the processing system infers, based on the first user input from the multiple users and the second user input, the fourth item, the processing system produces a second number;
determines that the second number is at or above the threshold;
in response to determining that the second number is at or above the threshold, provides, to the augmented reality device of the user, information associated with the fourth item.

67. The computer readable memory device of claim 64, wherein when the processing system infers, based on the first user input from the multiple users, the second item, different from the first item, the processing system utilizes multiple rules that match the first user input.

68. The computer readable memory device of claim 64, wherein when the processing system infers, based on the first user input from the multiple users, the second item, different from the first item, the processing system utilizes Bayesian inference.

69. The computer readable memory device of claim 64, wherein when the processing system infers, based on the first user input from the multiple users, the second item, different from the first item, the processing system produces a number;
wherein the processing system further determines that the number is at or above a threshold;
wherein, in response to determining that the number is at or above the threshold, the processing system provides, to the augmented reality device of the user, the at least one of the picture of the second item, the URL associated with the second item, the URI associated with the second item, the directions through the physical store to arrive at the second item, and the path through the physical store to arrive at the second item.

70. The computer readable memory device of claim 64, wherein the processing system further:
receives second user input from the user that indicates a selection of the second item; and
in response to receiving the second user input from the user that indicates the selection of the second item, presents an option of purchasing the second item via the augmented reality device.

71. The computer readable memory device of claim 64, wherein when the processing systems provides, to the augmented reality device of the user, the at least one of the picture of the second item, the URL associated with the second item, the URI associated with the second item, the directions through the physical store to arrive at the second item, and the path through the physical store to arrive at the second item, the processing system provides, to the augmented reality device of the user, the at least one of the picture of the second item, the URL associated with the second item, the URI associated with the second item, the directions through the physical store to arrive at the second item, and the path through the physical store to arrive at the second item via a network.

72. The computer readable memory device of claim 71, wherein the network includes a wide area network.

73. The computer readable memory device of claim 72, wherein the wide area network includes an Internet.

74. The computer readable memory device of claim 64, wherein the first user input from the multiple users further indicates one or more of a sport, a gender, a yearly income, an automobile type, a means of payment, an address, a marital status, a credit history, a past transaction, a past purchase, a music genre, an interest, an employment status, an age, a height, a weight, a hair color, an eye color, a shoe size, a dress size, a waist size, an inseam size, a breast size, a chest size, and a membership.

75. The computer readable memory device of claim 64, wherein when the processing system stores the first user input from the multiple users, the processing system stores the first user input from the multiple users via at least one database.

76. A method, comprising:
receiving first user input from multiple users that indicates at least one of a selection of a first item and a path through a first layout of a physical store;
storing the first user input from the multiple users;
inferring, based on the first user input from the multiple users, a second item, different from the first item; and
providing, to an augmented reality device of the user, at least one of a picture of the second item, a uniform resource locator (URL) associated with the second item, a uniform resource identifier (URI) associated with the second item, directions through the physical store to arrive at the second item, and a path through the physical store to arrive at the second item.

77. The method of claim 76, further comprising:
receiving second user input from the user that indicates at least a selection of the second item;
inferring, based on the first user input from the multiple users and the second user input, a third item, different from the first item and different from the second item; and
providing, to the augmented reality device of the user, at least one of a picture of the third item, a URL associated with the third item, a URI associated with the third item, directions through the physical store to arrive at the third item, and a path through the physical store to arrive at the third item.

78. The method of claim 76, further comprising:
receiving second user input from the user that indicates at least a selection of the second item;
inferring, based on the first user input from the multiple users and the second user input, a third item, different from the first item and different from the second item, wherein the inferring, based on the first user input from the multiple users and the second user input, the third item produces a first number;
determining that the first number is below a threshold;
inferring, based on the first user input from the multiple users and the second user input, a fourth item, different from the first item, different from the second item, and different from the third item, the inferring, based on the first user input from the multiple users and the second user input, the fourth item, produces a second number;
determining that the second number is at or above the threshold;
in response to the determining that the second number is at or above the threshold, providing, to the augmented reality device of the user, information associated with the fourth item.

79. The method of claim 76, the inferring, based on the first user input from the multiple users, the second item, different from the first item, includes utilizing multiple rules that match the first user input.

80. The method of claim 76, the inferring, based on the first user input from the multiple users, the second item, different from the first item includes utilizing Bayesian inference.

81. The method of claim 76, wherein the inferring, based on the first user input from the multiple users, the second item, different from the first item, produces a number;
the method further comprising:
determining that the number is at or above a threshold;
wherein, in response to determining that the number is at or above the threshold, performing the providing, to the augmented reality device of the user, the at least one of the picture of the second item, the URL associated with the second item, the URI associated with the second item, the directions through the physical store to arrive at the second item, and the path through the physical store to arrive at the second item.

82. The method of claim 76, further comprising:
receiving second user input from the user that indicates a selection of the second item; and
in response to receiving the second user input from the user that indicates the selection of the second item, presenting an option of purchasing the second item via the augmented reality device.

83. The method of claim 76, the providing, to the augmented reality device of the user, the at least one of the picture of the second item, the URL associated with the second item, the URI associated with the second item, the directions through the physical store to arrive at the second item, and the path through the physical store to arrive at the second item, includes providing, to the augmented reality device of the user, the at least one of the picture of the second item, the URL associated with the second item, the URI associated with the second item, the directions through the physical store to arrive at the second item, and the path through the physical store to arrive at the second item via a network.

84. The method of claim 83, wherein the network includes a wide area network.

85. The method of claim 84, wherein the wide area network includes an Internet.

86. The method of claim 76, wherein the first user input from the multiple users further indicates one or more of a sport, a gender, a yearly income, an automobile type, a means of payment, an address, a marital status, a credit history, a past transaction, a past purchase, a music genre, an interest, an employment status, an age, a height, a weight, a hair color, an eye color, a shoe size, a dress size, a waist size, an inseam size, a breast size, a chest size, and a membership.

87. The method of claim 76, the storing the first user input from the multiple users includes storing the first user input from the multiple users via at least one database.

88. A system, comprising:
means for receiving first user input from multiple users that indicates at least one of a selection of a first item and a path through a first layout of a physical store;
means for storing the first user input from the multiple users;
means for inferring, based on the first user input from the multiple users, a second item, different from the first item; and
means for providing, to an augmented reality device of the user, at least one of a picture of the second item, a uniform resource locator (URL) associated with the second item, a uniform resource identifier (URI) associated with the second item, directions through the physical store to arrive at the second item, and a path through the physical store to arrive at the second item.

89. The system of claim 88, further comprising:
means for receiving second user input from the user that indicates at least a selection of the second item;
means for inferring, based on the first user input from the multiple users and the second user input, a third item, different from the first item and different from the second item; and
means for providing, to the augmented reality device of the user, at least one of a picture of the third item, a URL associated with the third item, a URI associated with the third item, directions through the physical store to arrive at the third item, and a path through the physical store to arrive at the third item.

90. The system of claim 88, further comprising:
means for receiving second user input from the user that indicates at least a selection of the second item;
means for inferring, based on the first user input from the multiple users and the second user input, a third item, different from the first item and different from the second item, wherein the means for inferring, based on the first user input from the multiple users and the second user input, the third item produces a first number;
means for determining that the first number is below a threshold;
means for inferring, based on the first user input from the multiple users and the second user input, a fourth item, different from the first item, different from the second item, and different from the third item, wherein the means for inferring, based on the first user input from the multiple users and the second user input, the fourth item, produces a second number;
means for determining that the second number is at or above the threshold;
means for providing, to the augmented reality device of the user, information associated with the fourth item, in response to the determining that the second number is at or above the threshold.

91. The system of claim 88, the means for inferring, based on the first user input from the multiple users, the second item, different from the first item, includes means for utilizing multiple rules that match the first user input.

92. The system of claim 88, the means for inferring, based on the first user input from the multiple users, the second item, different from the first item include means for utilizing Bayesian inference.

93. The system of claim 88,
wherein the means for inferring, based on the first user input from the multiple users, the second item, different from the first item, produces a number;
the system further comprising means for determining that the number is at or above a threshold;
wherein the means for providing, to the augmented reality device of the user, the at least one of the picture of the second item, the URL associated with the second item, the URI associated with the second item, the directions through the physical store to arrive at the second item, and the path through the physical store to arrive at the second item, include means for providing, to the augmented reality device of the user, the at least one of the picture of the second item, the URL associated with the second item, the URI associated with the second item, the directions through the physical store to arrive at the second item, and the path through the physical store to arrive at the second item, in response to determining that the number is at or above the threshold.

94. The system of claim 88, further comprising:
means for receiving second user input from the user that indicates a selection of the second item; and
means for presenting an option of purchasing the second item via the augmented reality device in response to receiving the second user input from the user that indicates the selection of the second item.

95. The system of claim 88, wherein the means for providing, to the augmented reality device of the user, the at least one of the picture of the second item, the URL associated with the second item, the URI associated with the second item, the directions through the physical store to arrive at the second item, and the path through the physical store to arrive at the second item, include means for providing, to the augmented reality device of the user, the at least one of the picture of the second item, the URL associated with the second item, the URI associated with the second item, the directions through the physical store to arrive at the second item, and the path through the physical store to arrive at the second item via a network.

96. The system of claim 95, wherein the network includes a wide area network.

97. The system of claim 96, wherein the wide area network includes an Internet.

98. The system of claim 88, wherein the first user input from the multiple users further indicates one or more of a sport, a gender, a yearly income, an automobile type, a means of payment, an address, a marital status, a credit history, a past transaction, a past purchase, a music genre, an interest, an employment status, an age, a height, a weight, a hair color, an eye color, a shoe size, a dress size, a waist size, an inseam size, a breast size, a chest size, and a membership.

99. The system of claim 88, the means for storing the first user input from the multiple users include means for storing the first user input from the multiple users via at least one database.
